(19) United States
(12) Patent Application Publication
(10) Pub. No.: US 2023/0292175 A1
(43) Pub. Date: Sep. 14, 2023

(54) SYSTEMS, APPARATUS, ARTICLES OF MANUFACTURE, AND METHODS FOR PROCESSING WIRELESS DATA USING BASEBAND GATEWAYS

(71) Applicant: Casa Systems, Inc., Andover, MA (US)

(72) Inventors: Hongwei Kong, Basking Ridge, NJ (US); Henry Ye, Andover, MA (US)

(73) Assignee: Casa Systems, Inc., Andover, MA (US)

(21) Appl. No.: 18/182,666

(22) Filed: Mar. 13, 2023

Related U.S. Application Data
(60) Provisional application No. 63/319,431, filed on Mar. 14, 2022.

(51) Int. Cl. H04W 28/06

(52) U.S. Cl. CPC H04W 28/06; H04W 88/16

(57) ABSTRACT

The techniques described herein relate to systems, apparatus, articles of manufacture, and methods for processing wireless data using baseband gateways. An example method includes decompressing wireless data received from a radio unit to generate first decompressed data; combining the first decompressed data with second decompressed data to generate combined decompressed data, wherein the second decompressed data is associated with the radio unit; performing baseband processing on the combined decompressed data to generate baseband processed data; and transmitting the baseband processed data to a mid-haul network.

### RELATED APPLICATION

This patent claims priority under 35 U.S.C. § 119(e) to U.S. Provisional Application No. 63/319,431, titled “CELLULAR BASEBAND UNIT GATEWAY,” filed on Mar. 14, 2022, which is hereby incorporated by reference herein in its entirety.

### FIELD

The techniques described herein relate generally to wireless networks and, more particularly, to systems, apparatus, articles of manufacture, and methods for processing wireless data using baseband gateways.

### BACKGROUND

Multiple generations of standards are used in the telecommunications (“telecom”) industry. Some exemplary standards are set forth by the Open Radio Access Network (O-RAN) Alliance, such as the O-RAN Architecture Description (e.g., O-RAN Alliance specification O-RAN.WG1.O-RAN-Architecture-Description-v07.00 or later), which specify exemplary telecom architectures and related functions and interfaces to implement mobile networks. A mobile network, such as a mobile network based on the O-RAN Architecture, may include a front-haul portion implemented by a front-haul interface, which facilitates communication between a radio unit and a base station. Some front-haul portions may include intermediary devices such as gateways and/or switches to implement different cellular deployments.

### SUMMARY OF THE DISCLOSURE

In accordance with the disclosed subject matter, apparatus, systems, and methods are provided for processing wireless data using baseband gateways.

Some embodiments relate to a method for processing wireless data by a baseband gateway in a cell deployment. The method comprises decompressing wireless data received from a radio unit to generate first decompressed data; combining the first decompressed data with second decompressed data to generate combined decompressed data, wherein the second decompressed data is associated with the radio unit; performing baseband processing on the combined decompressed data to generate baseband processed data; and transmitting the baseband processed data to a mid-haul network.

Some embodiments relate to a baseband gateway for processing wireless data in a cell deployment. The baseband gateway comprises at least one memory; machine-readable instructions; and processor circuitry to execute the machine-readable instructions to at least: decompress wireless data received from a radio unit to generate first decompressed data; combine the first decompressed data with second decompressed data to generate combined decompressed data, wherein the second decompressed data is associated with the radio unit; perform baseband processing on the combined decompressed data to generate baseband processed data; and cause transmission of the baseband processed data to a mid-haul network.

Some embodiments relate to at least one non-transitory computer-readable storage medium comprising instructions that, when executed, cause a baseband gateway to at least: decompress wireless data received from a radio unit to generate first decompressed data; combine the first decompressed data with second decompressed data to generate combined decompressed data, wherein the second decompressed data is associated with the radio unit; perform baseband processing on the combined decompressed data to generate baseband processed data; and cause transmission of the baseband processed data to a mid-haul network.

Some embodiments relate to another method for processing wireless data by a baseband gateway in a cell deployment. The method comprises performing baseband processing on network data from a mid-haul network to generate baseband processed data; distributing at least portions of the baseband processed data to respective network interface paths; compressing the portions of the baseband processed data to generate compressed data portions; and transmitting the compressed data portions to respective radio units.

Some embodiments relate to another baseband gateway for processing wireless data in a cell deployment. The baseband gateway comprises at least one memory; machine-readable instructions; and processor circuitry to execute the machine-readable instructions to at least: perform baseband processing on network data from a mid-haul network to generate baseband processed data; distribute at least portions of the baseband processed data to respective network interface paths; compress the portions of the baseband processed data to generate compressed data portions; and transmit the compressed data portions to respective radio units.

Some embodiments relate to another at least one non-transitory computer-readable storage medium comprising instructions that, when executed, cause a baseband gateway to at least: perform baseband processing on network data from a mid-haul network to generate baseband processed data; distribute at least portions of the baseband processed data to respective network interface paths; compress the portions of the baseband processed data to generate compressed data portions; and transmit the compressed data portions to respective radio units.

The foregoing summary is not intended to be limiting. Moreover, various aspects of the present disclosure may be implemented alone or in combination with other aspects.

### BRIEF DESCRIPTION OF FIGURES

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 is an illustration of a conventional cellular network that includes a front-haul multiplexer as part of a front-haul network.

FIG. 2 is a block diagram of a conventional implementation of a front-haul multiplexer connected to a distributed unit and a radio unit.

FIG. 3 is an illustration of downlink flow of a conventional network cell in front-haul multiplexer mode.

FIG. 4 is an illustration of uplink flow of the conventional network cell of FIG. 3 in front-haul multiplexer mode.

FIG. 5 is an illustration of downlink flow of a conventional network cell in cascade mode.

FIG. 6 is an illustration of uplink flow of the conventional network cell of FIG. 5 in cascade mode.

FIG. 7 is a data flow diagram of configuring a conventional cellular network for shared cell operation.

FIG. 8 is an illustration of an example implementation of a cellular network that includes a distributed unit gateway as part of a front-haul network, according to some embodiments.

FIG. 9 is a block diagram of an example implementation of the distributed unit gateway of FIG. 8 connected to a mid-haul network and a radio unit, according to some embodiments.

FIG. 10 is a block diagram of another example implementation of the distributed unit gateway of FIG. 8, according to some embodiments.

FIG. 11 is a first example network cell configuration including a single network cell with a single radio unit, according to some embodiments.

FIG. 12 is a second example network cell configuration including a single network cell with a plurality of radio units, according to some embodiments.

FIG. 13 is a data flow diagram corresponding to example operation of the second network cell configuration of FIG. 12, according to some embodiments.

FIG. 14 is a third example network cell configuration including multiple network cells each with a plurality of radio units, according to some embodiments.

FIG. 15 is a fourth example network cell configuration including multiple example distributed unit gateways respectively associated with multiple network cells, according to some embodiments.

FIG. 16 is a fifth example network cell configuration including multiple example distributed unit gateways respectively associated with multiple overlapping network cells, according to some embodiments.

FIG. 17 is a data flow diagram corresponding to example operation of the third network cell configuration of FIG. 14, the fourth network cell configuration of FIG. 15, or the fifth network cell configuration of FIG. 16, according to some embodiments.

FIG. 18 is a flowchart representative of example machine-readable instructions that may be executed by processor circuitry to implement the distributed unit gateway of FIGS. 8, 9, and/or 10 to implement an uplink path of a cellular network, according to some embodiments.

FIG. 19 is another flowchart representative of example machine-readable instructions that may be executed by processor circuitry to implement the distributed unit gateway of FIGS. 8, 9, and/or 10 to implement an uplink path of a cellular network, according to some embodiments.

FIG. 20 is a flowchart representative of example machine-readable instructions that may be executed by processor circuitry to implement the distributed unit gateway of FIGS. 8, 9, and/or 10 to implement a downlink path of a cellular network, according to some embodiments.

FIG. 21 is another flowchart representative of example machine-readable instructions that may be executed by processor circuitry to implement the distributed unit gateway of FIGS. 8, 9, and/or 10 to implement a downlink path of a cellular network, according to some embodiments.

FIG. 22 is a flowchart representative of example machine-readable instructions that may be executed by processor circuitry to implement the distributed unit gateway of FIGS. 8, 9, and/or 10 to perform network port scanning for a front-haul interface of a cellular network, according to some embodiments.

FIG. 23 is a flowchart representative of example machine-readable instructions that may be executed by processor circuitry to implement the distributed unit gateway of FIGS. 8, 9, and/or 10 to perform updates associated with utilization improvements of the distributed unit gateway, according to some embodiments.

FIG. 24 is a flowchart representative of example machine-readable instructions that may be executed by processor circuitry to implement the distributed unit gateway of FIGS. 8, 9, and/or 10 to perform updates associated with location accuracy improvements of the distributed unit gateway, according to some embodiments.

FIG. 25 is an electronic platform structured to execute the machine-readable instructions of FIGS. 18-24 to implement the distributed unit gateway of FIGS. 8, 9, and/or 10, according to some embodiments.

### DETAILED DESCRIPTION

The present application provides techniques for processing wireless data using baseband gateways. Wireless data may be implemented as cellular data generated, received, and/or transmitted in accordance with various cellular standards and/or architectures, such as third generation cellular (e.g., 3G), fourth generation long-term evolution cellular (e.g., 4G LTE), fifth generation cellular (e.g., 5G), future sixth generation cellular or next generation cellular, etc., standards and/or architectures. For example, wireless data may be transmitted and/or received by an electronic device associated with an end user (e.g., user equipment (UE)) in a telecommunications network (e.g., sometimes “telecom network” or “Telcom network”).

In some examples, the telecom network may be implemented by an architecture based on a standard associated with the 3rd Generation Partnership Project (“3GPP”), the Open Radio Access Network (O-RAN) Alliance (“O-RAN Alliance”), or the like. For example, the telecom network may be a mobile communication network based on an architecture as set forth in the O-RAN Architecture Description (e.g., O-RAN Alliance Specification O-RAN.WG1.O-RAN-Architecture-Description-v07.00 or later).

A mobile network, such as a mobile network based on the O-RAN architecture, may include several network portions to facilitate data transfer within the mobile network. For example, the mobile network may include a front-haul portion, a mid-haul portion, and a back-haul portion. In some examples, first components, functions, etc., of the front-haul portion are communicatively and/or physically coupled to second components, functions, etc., of the mid-haul portion. In some examples, the second components/functions, etc., of the mid-haul portion may be communicatively and/or physically coupled to third components, functions, etc., of the back-haul portion.

In some examples, the front-haul portion may be implemented by a front-haul interface, which facilitates communication between a transceiver, such as a radio unit (RU) (also referred to as an “O-RU” when utilized in O-RAN mobile networks), and a baseband signal processor, such as a baseband unit (BBU) of a base station. For example, in a 4G LTE O-RAN mobile network, the RU and the BBU may implement an eNodeB (eNB), which refers to a node that provides connectivity between UE and the 4G Core (also referred to as the “evolved packet core (EPC),” the “core network,” or the “4G core network”). In some examples, the BBU may be functionally split into a distributed unit (DU) (also referred to as an O-DU when utilized in O-RAN mobile networks) and a centralized unit (CU) (also referred to as a “control unit,” “a central unit,” or an “O-CU” when utilized in O-RAN mobile networks). For example, in a 5G O-RAN mobile network, the O-DU and the O-CU may implement a gNodeB (gNB), which refers to a node that provides connectivity between UE and the 5G Core (also referred to as the “core network” or the “5G core network”).

In some examples, the mid-haul portion may be implemented by a mid-haul interface, which facilitates communication between the functions of the base station. For example, the mid-haul interface may be implemented by the communication interface between the DU and the CU. In some examples, the back-haul portion may be implemented by a back-haul interface, which facilitates communication between the CU and the 5G Core. In some instances, the 5G core may be in communication with a central facility associated with one or more servers to process a request associated with the wireless data from the UE, push information to the UE via the back-haul through front-haul interfaces, etc. Alternatively in other types of mobile networks, such as a 4G LTE network, the back-haul portion may be implemented by a back-haul interface that facilitates communication between the BBU and the 4G Core.

In some examples, the RU, DU, and/or CU may split the hosting of different gNB functions (or eNB functions with respect to 4G LTE implementations) based on the deployed architecture. By way of example, an O-RAN mobile network architecture may functionally and/or physically split the lower layer of the front-haul interface based on Split Architecture Option 7-2x as specified by O-RAN Control, User and Synchronization Plane Specification 10.0 (e.g., O-RAN Alliance Specification O-RAN.WG4.CUS.0-v10.00 or later). For example, the O-RU may host low physical (PHY) layer and radio-frequency (RF) processing and the O-DU may host high-PHY, media access control (MAC), and radio link control (RLC) processing based on the lower layer functional split. The O-RU implementation may be less complex by having the O-RU host fewer functions by shifting functions from the O-RU to the O-DU. As a result, the O-RU may have reduced memory requirements and may execute fewer real-time calculations and thereby enable reduced latency in the mobile network.

Different portions of mobile networks may be located and/or used in a variety of environments, such as indoor and outdoor deployments. In indoor/outdoor environments, physical separation of RUs and BBUs, such as DUs, are typical due to the flexibility in implementing coverage extension. For example, RUs can be installed in rural areas and/or challenging environments where user density is low, on an as-needed basis, without the need to change the location of the DUs, and/or without the need to upgrade the capacity, utilization, and/or capabilities of the DUs. In some instances, RUs can be installed in high-density user scenarios (e.g., apartment buildings, shopping malls, sports stadiums, etc.). In some such instances, multiple RUs belonging to the same cell (e.g., the same network cell) may be deployed to minimize and/or otherwise reduce intercell interference and frequent UE handovers.

The front-haul interface of a mobile network may be implemented by different one(s) of communication functions dependent on the type of deployment and requirements of the mobile network to be implemented. For example, in deployment scenarios in which multiple RUs are connected to the BBU (e.g., the DU) via communication links, such as optical Ethernet links, accurate time and frequency synchronization may be required among the RUs and the BBU. In some examples, the synchronization may be implemented by a synchronization function, such as the Institute of Electrical and Electronics Engineers (IEEE) 1588 Precision Time Protocol, over the front-haul network to synchronize the RUs and the BBU.

In some examples, the front-haul interface may be implemented by a gateway function, such as a front-haul gateway (FHGW or FHG) function, to move traffic between the RUs and the BBU when protocol translation is to be supported. Additionally or alternatively, the front-haul interface may be implemented by a front-haul multiplexer (FHM) function and/or a front-haul switch (FHS) function. Such FHM or FHS functions may not support protocol translation. In some examples, the FHM function may include the FHS function, RU downlink copy function, and uplink (UL) signal aggregation function. In some examples, the front-haul interface may be implemented by an FHS that supports Telecom-Boundary Clock (T-BC) when DU connections exist to multiple RUs. In some examples, either an FHM function or cascaded RUs may be used in deployments with multiple RUs for a single cell. For example, the multiple RUs may have shared PHY and MAC processing to implement the shared single cell. The cascaded RUs may include RUs with the capability of aggregating the UL signal and copying the downlink signal from/to another RU.

The inventors have recognized that an increase in the number and/or complexity of communication functions to implement a front-haul interface may have adverse effects on component and/or overall system performance. For example, a high-density deployment may utilize a DU capable of executing a significant number and/or type of communication functions (e.g., real-time communication functions, non-real-time communication functions, etc.). The DU may be implemented with a significant number and/or different types of hardware to effectuate the communication functions. Such a DU may be physically large to accommodate the hardware and may be computationally and/or monetarily expensive. For example, such a DU may utilize a significant number of compute, memory, and/or other type of hardware resource(s) to accommodate the different communication functions.

The inventors have recognized that conventional hardware, such as Ethernet switches, FHMs, or the like are deficient in various ways when used to implement front-haul interfaces for complex, flexible wireless network deployments. For example, Ethernet switches that support T-BC are physically bulky and computationally and/or monetarily expensive due to the increased hardware (and corresponding firmware and/or software) used to execute and/or manage T-BC. Additionally, Ethernet switches do not have the UL data aggregation and combine functions needed to support shared cell functions, deployments, etc.

The inventors have recognized that FHMs do not overcome the deficiencies of Ethernet switches for implementing front-haul interfaces. For example, an FHM may operate as an Ethernet switch that supports T-BC and may be capable of aggregating and combining UL traffic. However, an FHM uses additional communication functions when processing UL traffic, which increases latency and reduces bandwidth of the FHM and the associated overall system. For example, after an FHM receives a UL signal from an RU, the FHM may decompress the UL signal, combine the UL signal with other UL signals (e.g., UL signals corresponding to the same radio resource element), and recompress the combined UL signals. The additional functions (e.g., the decompressing, combining, recompressing, etc.) introduces signal quality loss and increases processing latency that consumes a significant portion of the front-haul latency budget (e.g., the amount of acceptable latency in the front-haul as specified by the relevant architectural standard). Although the FHM may handle UL traffic from multiple RUs, the additional communication functions needed to handle such UL traffic may cause the noise floor to rise as the number of RUs connected to the FHM increase. Additionally, the FHM may lack desired functions such as location determination functions as the FHM may be unable to identify a location of a UE based on UL traffic.

The inventors have also recognized that changing an architecture of a front-haul interface does not overcome the aforementioned deficiencies. For example, a cascaded RU architecture may support shared cell functions without an FHM, but such an architecture may include multiple rounds of decompress/combine/recompress of the UL signals, which adds latency and further signal quality degradation. A cascaded RU architecture may also reduce deployment flexibility as all cascaded RUs must be on the same network cell. Such an architecture may diminish network resiliency as a cascaded RU architecture is vulnerable to the breakdown of a single RU, especially the north-most node in the cascade chain.

Recognizing the above challenges, the inventors have developed disclosed systems, apparatus, articles of manufacture, and methods for processing wireless data using baseband gateways to achieve reduced latency, increased bandwidth, and/or increased signal quality in wireless network deployments. In some disclosed examples, the front-haul interface of the wireless network deployments may be implemented at least in part by a baseband gateway (also referred to herein as a DU gateway). For example, the baseband gateway may be implemented by a single physical hardware unit that consolidates RU gateway/switch and DU functions. For example, the baseband gateway may perform data interface functions (e.g., receive data from and/or transmit data to RU(s)) to eliminate an Ethernet switch and/or an FHM from the front-haul portion of the wireless network deployment. Such an approach is a paradigm shift from conventional industry approaches, which instead use separate physical devices to implement the baseband gateway and the FHM, as explained above. Accordingly, conventional approaches maintain a physical separation between the baseband gateway and FHM (e.g., since the baseband gateway and FHM may not be located near each other in deployments). Advantageously, the example baseband gateway may include multiple DU instances that can support multiple network cells and thereby support a reduced footprint of the DU gateway enclosure. For example, the DU instances may be software implementations (e.g., virtual machines, containers, etc., instantiated by multi-core processor circuitry) that carry out a variety of functions such as PHY (e.g., high-PHY), MAC, and/or RLC processing to process and route signals to/from one or more RUs connected (e.g., directly connected) to the baseband gateway.

Advantageously, the example baseband gateway as disclosed herein reduces latency when processing UL and/or downlink (UL) traffic. For example, the baseband gateway may be structured to avoid the performing of additional round(s) of decompress/combine/recompress as in FHM and cascade RU deployments to achieve reduced latency and improved signal quality. Advantageously, the example baseband gateway may achieve increased bandwidth by analyzing its capacity, utilization, etc., and obtaining firmware and/or software updates to increase its capabilities to support increased data traffic. As a result, network management can be simplified due to fewer devices to maintain in deployments, reduced physical port usage in deployments, and/or additional flexibility offered through software control that is not available with conventional deployments. For example, software port mapping can replace physical port mappings between FHMs and DUs, which can be easily updated and/or reconfigured without requiring manual intervention.

Advantageously, the example baseband gateway may consolidate RU gateway/switch and DU functions to obtain new insights based on analysis of processed UL traffic. For example, the baseband gateway may analyze RU UL signals in association with DU processing to identify a location of UE based on an RU of which the UE is connected and/or timing and synchronization data associated with communication between the RU and the UE. Such analysis is not possible in conventional deployments, because RU data is combined by the FHM prior to receipt by the DU, and thus the DU is unable to analyze separate RU signals.

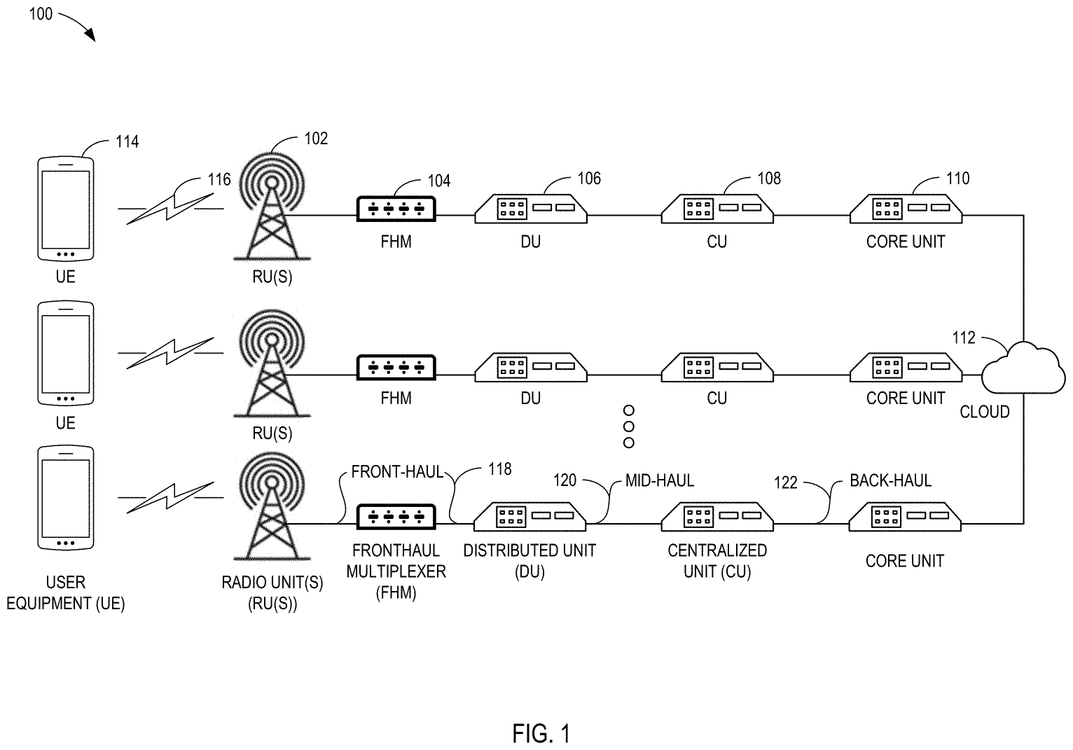

Turning to the figures, the illustrated example of FIG. 1 is an illustration of a conventional cellular network 100 that includes radio units (RUs) 102, front-haul multiplexers (FHMs) 104, distributed units (DUs) 106, centralized units (CUs) 108, core units 110, and a cloud 112. The cellular network 100 of FIG. 1 is a 5G network system based on an Open Radio Access Network (O-RAN) architecture. Although illustrated with reference to 5G network systems, it should be appreciated that other network configurations and/or architectures are also possible. For example, the techniques described herein could also be applied to other network systems such as 4G LTE network systems or future sixth generation (6G) network systems, as the techniques described herein are not limited in this respect. Although illustrated with reference to O-RAN architectures, other network architectures are also possible. For example, techniques described herein could also be applied to other architectures such as a 3rd Generation Partnership Project (3GPP) or a Small Cell Forum (SCF) architecture.

In the illustrated example, each of the depicted RU(s) 102 may be one or more RUs. The RUs 102 are logical nodes that may host low physical (PHY) layer and/or radio-frequency (RF) processing based on a lower layer functional split, such as Split Architecture Option 7-2x as specified by O-RAN Control, User and Synchronization Plane Specification 10.0 (e.g., O-RAN Alliance Specification O-RAN.WG4.CUS.0-v10.00 or later). The RUs 102 may be implemented by hardware alone, or by a combination of hardware, software, and/or firmware. For example, the RUs 102 may be implemented by transceivers that transmit or receive radio waves, and/or associated software and/or firmware.

The RUs 102 are in communication with user equipment (UE) 114 via communication links 116. In this example, the UE 114 are handheld devices, such as Internet-enabled smartphones. Additionally or alternatively, the UE 114 may be any type of electronic device such as a laptop computer, a tablet computer, autonomous equipment (e.g., an autonomous vehicle, a drone, etc.), an Internet-of-Things (IoT) device, etc.

The communication links 116 are wireless connections. For example, the wireless connections may be 4G LTE wireless connections, 5G wireless connections, future generation (e.g., 6G) wireless connections, or the like. In some examples, the wireless connections may be implemented by a 5G 3GPP protocol, a future generation 3GPP protocol, etc. In some examples, the wireless connections may be compatible across generations of 3GPP protocols. For example, the RUs 102 may communicate with some of the UE 114 using a 4G 3GPP protocol and with other ones of the UE 114 using a 5G 3GPP protocol.

Additionally or alternatively, the communication links 116 may be wired connections (e.g., fiber-optic connections, Ethernet connections, etc.) or other type of wireless connections such as satellite connections (e.g., beyond-line-of-site (BLOS) satellite connections, line-of-site (LOS) satellite connections, etc.), Ultra Wideband (UWB) connections, etc.

In operation, the RUs 102 may receive wireless data, such as cellular data implemented by RF signals, from the UE 114 via the communication links 116. The RUs 102 may output the received data to the FHMs 104. The FHMs 104 of this example are devices that host, execute, etc., a multiplexing function for splitting and combining radio signals to or from the RUs 102. For example, the FHMs 104 may receive radio signals (e.g., baseband signals) from ones of the first RUs 102, combine the radio signals, and output the combined radio signals to one of the DUs 106.

In operation, the RUs 102 may transmit wireless data. For example, the DUs 106 may receive network data, the DUs 106 may perform baseband processing on the network data to generate baseband processed data, the DUs 106 may output the baseband processed data to the FHMs 104, the FHMs 104 may split the baseband processed data into different network paths, the FHMs 104 may output the split network data to ones of the RUs 102 along the different network paths, and the ones of the RUs 102 may transmit their respective network data portions to a node destination, such as one(s) of the UE 114.

The DUs 106 of this example are logical nodes that may host baseband functions such as high physical layer (PHY), radio link control (RLC), and/or media access control (MAC) processing based on a lower layer functional split, such as Split Architecture Option 7-2x as specified by O-RAN Control, User and Synchronization Plane Specification 10.0 (e.g., O-RAN Alliance Specification O-RAN.WG4.CUS.0-v10.00 or later). The DUs 106 may be implemented by hardware alone, or may be implemented by a combination of hardware, software, and/or firmware.

The CUs 108 are logical nodes that may host control functions, such as Packet Data Convergence Protocol (PDCP), Radio Resource Control (RRC), and/or Service Data Adaptation Protocol (SDAP). The CUs 108 may be implemented by hardware alone, or may be implemented by a combination of hardware, software, and/or firmware.

In this example, the core units 110 are logical nodes that may host data and control plane operations. The core units 110 of this example are the 5G Core (5GC) and may facilitate communication between the CUs 108 and the cloud 112. The cloud 112 may be a cloud network. For example, the cloud 112 may be network(s) hosted by a public cloud provider, a private cloud provider, a telecommunications operator, etc. In some examples, the cloud 112 may be implemented by one or more physical hardware servers, virtualizations of the one or more physical hardware servers, etc., and/or any combination(s) thereof.

The cellular network 100 of the illustrated example includes network portions such as a front-haul portion 118, a mid-haul portion 120, and a back-haul portion 122. The front-haul portion 118 of this example is implemented by the communication interfaces between the RUs 102 and the FHMs 104 and the communication interfaces between the FHMs 104 and the DUs 106. The mid-haul portion 120 is implemented by the communication interfaces between the DUs 106 and the CUs 108. The back-haul portion 122 is implemented by the communication interfaces between the CUs 108 and the core units 110.

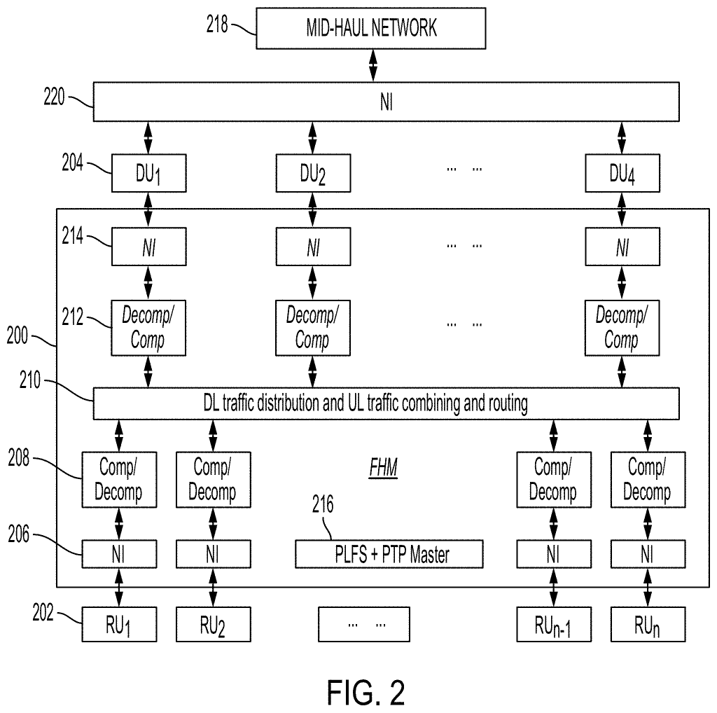

FIG. 2 is a block diagram of a conventional implementation of an FHM 200 connected to RUs 202 and DUs 204. For example, the FHM 104 of FIG. 1 may be implemented by the FHM 200 of FIG. 2. The RUs 102 of FIG. 1 may be implemented by the RUs 202 of FIG. 2. The DUs 106 of FIG. 1 may be implemented by the DUs 204 of FIG. 2.

The FHM 200 of FIG. 2 hosts communication functions to facilitate the flow of data traffic in a wireless network, such as the cellular network 100 of FIG. 1. The FHM 200 includes first network interfaces (NIs) 206, compression/decompression (COMP/DECOMP) functions 208, a downlink (DL) traffic distribution and uplink (UL) traffic combining and routing function 210, decompression/compression (DECOMP/COMP) functions 212, second NIs 214, and Physical Layer Frequency Signal (PLFS) protocol and Precision Time Protocol (PTP) protocol functions 216. The PLFS and PTP protocol functions 216 in this example may synchronize one(s) of the RUs 202 with the FHM 200 using PLFS and PTP. For example, the FHM 200 may be a PTP master that controls and/or manages the synchronization operations.

In example operation, such as when handling UL traffic, the first NIs 206 in this example receive data (e.g., baseband data, wireless data, RF data, etc.) from a respective one of the RUs 202. The received data may be compressed data, such as data compressed by the RUs 202 prior to transmission from the RUs 202 to the first NIs 206. The comp/decomp functions 208 decompress the received data to generate decompressed data and output the decompressed data to the DL traffic distribution and UL traffic combining and routing function 210. When handling UL traffic, the DL traffic distribution and UL traffic combining and routing function 210 combines data that is received by one or more of the first NIs 206 to generate combined decompressed data. The data that is combined may include the decompressed data and other decompressed data that correspond to the same radio resource element, such as RU₁ of the RUs 202. For example, RU₁ may transmit data associated with the same UE in portions and the DL traffic and UL traffic combining and routing function 210 may combine (e.g., reassemble) the transmitted portions into a combined data structure (e.g., the combined decompressed data).

When handling UL traffic, the DL traffic distribution and UL traffic combining and routing function 210 may output the combined decompressed data to the decomp/comp functions 212. The decomp/comp functions 212 may recompress the data to generate combined compressed data. The decomp/comp functions 212 may output the combined compressed data to the NIs 214, which forward the combined compressed data to the DUs 204 for baseband processing.

The DUs 204 of this example are physical hardware devices. For example, a first one of the DUs 204 (identified by DU₁) and a second of the DUs 204 (identified by DU₂) are each a single physical hardware device implemented by a combination of hardware, software, and/or firmware.

In example operation, such as when handling DL traffic, the second NIs 214 receive network data from the DUs 204. The network data may be compressed data. The second NIs 214 may output the network data to the decomp/comp functions 212. The decomp/comp functions 212 may decompress the network data to generate decompressed data and thereby enable the FHM 200 to process the decompressed data. For example, if the compressed data is to be copied and distributed along respective network paths, the decomp/comp functions 212 may pass along the compressed data without performing decompression functions on the compressed data. The decomp/comp functions 212 may output the decompressed data to the DL traffic distribution and UL traffic combining and routing function 210 for distribution of the decompressed data to one(s) of the RUs 202 along respective network paths. For example, a first network path may include a first one of the comp/decomp functions 208 and a first one of the first NIs 206 communicatively coupled to the first one of the comp/decomp functions 208.

When handling DL traffic, the DL traffic distribution and UL traffic combining and routing function 210 may generate copies of the decompressed data, such as a first copy of the decompressed data, or portion(s) thereof, and a second copy of the decompressed data, or portion(s) thereof. For example, the DL traffic distribution and UL traffic combining and routing function 210 may copy an entirety of the decompressed data or portion(s) of the decompressed data, such as only the payload (and/or header(s)) of the decompressed data. In this example, the DL traffic distribution and UL traffic combining and routing function 210 may output the first copy to a first one of the comp/decomp functions 208 and the second copy to a second one of the comp/decomp functions 208. The first and second ones of the comp/decomp functions 208 may recompress the decompressed data (or decompressed data portions) to generate compressed data (or recompressed data). The first and second ones of the comp/decomp functions 208 may output the compressed data to a respective one of the first NIs 206 for subsequent transmission to ones of the RUs 202. For example, the first one of the comp/decomp functions 208 may output the first copy to a first one of the first NIs 206, the second one of the comp/decomp functions 208 may output the second copy to a second one of the first NIs 206, etc. The first one of the first NIs 206 may transmit the first copy to a first UE via a first one of the first RUs 202 (identified by RU₁), the second one of the first NIs 206 may transmit the second copy to the first UE and/or a second UE via a second one of the first RUs 202 (identified by RU₂), etc.

In some examples, the comp/decomp functions 208 and/or the decomp/comp functions 212 may execute a compression algorithm, technique, operations, etc., such as block floating point compression (e.g., block floating point compression technique, function, or algorithm) to facilitate data flow through the FHM 200. In block floating point compression, for each physical resource block (PRB), In-phase (I) and Quadrature (Q) samples are converted to floating point format. The samples are represented as signed mantissa and a shared exponent. The compression algorithm receives 12 subcarriers with 24 uncompressed I and Q samples. The I and Q samples are subsequently compressed to a signed, fixed bit width integer mantissa and 4-bit unsigned integer exponent. In such a compression algorithm, the exponent is included for each compression block to be sent per PRB. The comp/decomp functions 208 and/or the decomp/comp functions 212 may execute block floating point decompression to decompress data that is compressed per block floating point compression as described above. Block floating point decompression may be executed by performing block floating point compression in reverse. Additionally or alternatively, the comp/decomp functions 208 and/or the decomp/comp functions 212 may execute any other type of compression (or decompression) algorithm, technique, operation, etc., on data, such as block scaling compression (or block scaling decompression), p-Law compression (or p-Law decompression), beamspace compression (or beamspace decompression), modulation compression (or modulation decompression), and/or the like.

The FHM 200 may operate with reduced performance because of the decomp/comp functions 212 and the second NIs 214. For example, the comp/decomp functions 208 may degrade signal quality and the additional stage of decompression (e.g., for DL traffic), when performed, or compression (e.g., for UL traffic) of the decomp/comp functions 212 may further degrade signal quality. In some examples, the second NIs 214 may increase latency associated with the FHM 200, and/or, more generally, with the front-haul, such as the front-haul portion 118 of FIG. 1, because of the additional receive and/or transmission functions to be executed by the second NIs 214.

In some examples, the FHM 200 may have reduced visibility into which UE is/are connected to a wireless network and, thus, may not be able to determine a location of the UE. For example, the FHM 200 may be implemented based on the O-RAN specification, which does not specify signals at the FHM 200 for UE location determination. In some examples, the RUs 202 may determine which UE is/are connected to one(s) of the RUs 202, but the FHM 200 may not have a function specified to analyze data from the RUs 202 to determine locations of UE connected to the RUs 202.

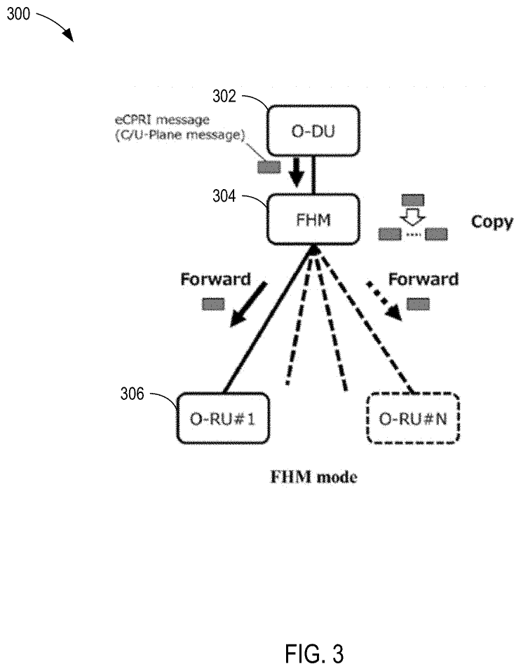

FIG. 3 is an illustration of downlink flow of a first conventional network cell 300 in FHM mode. The first network cell 300 of FIG. 3 includes an O-DU 302, an FHM 304, and O-RUs 306. In this example, the O-DU 302 is connected to the FHM 304 via an Enhanced Common Public Radio Interface (eCPRI), and the FHM 304 is connected to the O-RUs 306.

The first network cell 300 is a cell deployment including the O-RUs 306. The first network cell 300 of the illustrated example is a shared cell deployment. As used herein, “shared cell” is specified as the operation for the same cell, which can have one or more multiple component carrier(s), by several RUs. Component carriers are frequency blocks used to transmit data.

In FHM mode, the shared cell may be implemented by placing an FHM function, which may be implemented by the FHM 304, between the O-DU 302 and the O-RUs 306 that may have one or more component carriers from the O-RUs 306. In the illustrated example of FIG. 3, the FHM 304 may be modeled as an O-RU with lower layer split (LLS) front-haul support along with the copy and combine function, but without radio transmission/reception capability. For example, the FHM 304 may receive an eCPRI message from the O-DU 302, copy the eCPRI message into multiple instances of the eCPRI message, and forward the instances to respective ones of the O-RUs 306.

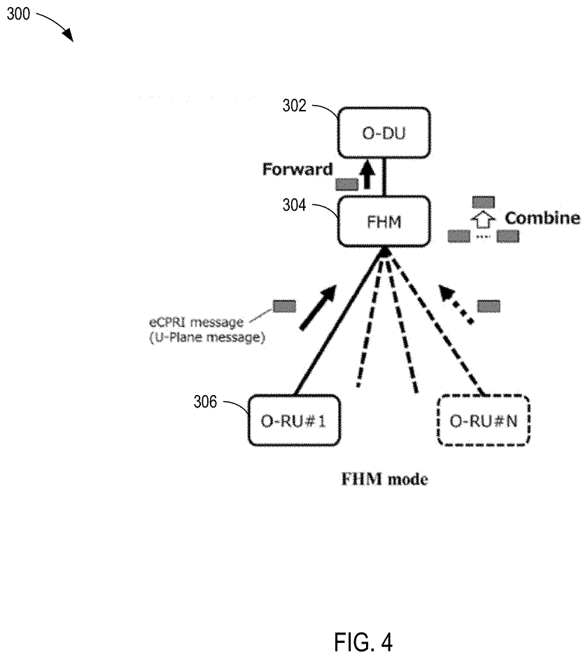

FIG. 4 is an illustration of uplink flow of the first conventional network cell 300 in FHM mode. In example operation, the FHM 304 may receive eCPRI messages from the O-RUs 306, decompress the eCPRI messages, combine one(s) of the eCPRI messages that correspond to the same radio resource element (e.g., the same one of the O-RUs 306) into combined eCPRI message(s), recompress the combined one(s) of the eCPRI messages, and forward the recompressed, combined eCPRI message(s) to the O-DU 302.

In some examples, the FHM 304 of FIGS. 3 and 4 may reduce performance of the first conventional network cell 300. For example, the eCPRI interface between the O-DU 302 and the FHM 304 may add latency to the first conventional network cell 300 when compared to an implementation that includes a direct connection between the O-DU 302 and the O-RUs 306. In some examples, the FHM 304 may add latency to the first conventional network cell 300 by performing additional processing to facilitate communication between the O-DU 302 and the O-RUs 306, such as performing an additional decompression operation (in O-DU 302) or an additional compression operation (in the FHM 304). In some examples, the FHM 304 and the O-DU 302 may degrade signal quality by performing the additional processing, such as by performing additional round(s) of data compression and/or decompression.

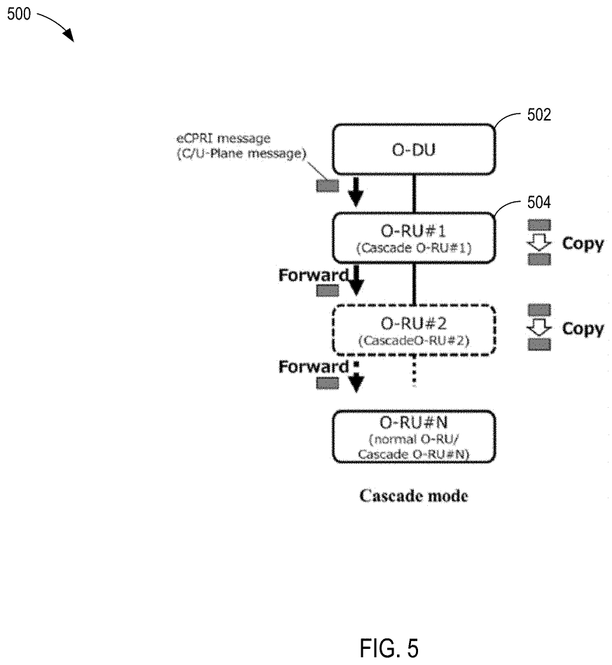

FIG. 5 is an illustration of downlink flow of a second conventional network cell 500 in cascade mode. The second network cell 500 of FIG. 5 includes an O-DU 502 and O-RUs 504. In this example, the O-DU 502 is connected to a first one of the O-RUs 504 (identified by O-RU #1) via eCPRI, and the O-RUs 504 are connected to each other in a cascade chain arrangement. For example, O-RU #1 is connected to O-RU #2, which is connected to another O-RU, such as O-RU #3, which is connected to another O-RU, such as O-RU #N, and so on.

In example operation, a first one of the O-RUs 504 (identified by O-RU #1) may receive an eCPRI message from the O-DU 502, copy the eCPRI message, and forward the copy to a second one of the O-RUs 504 (identified by O-RU #2). The second one of the O-RUs 504 may perform the same operation to forward another copy of the eCPRI message to a third one of the O-RUs 504, and so on, until the eCPRI message reaches a south-most one of the O-RUs 504.

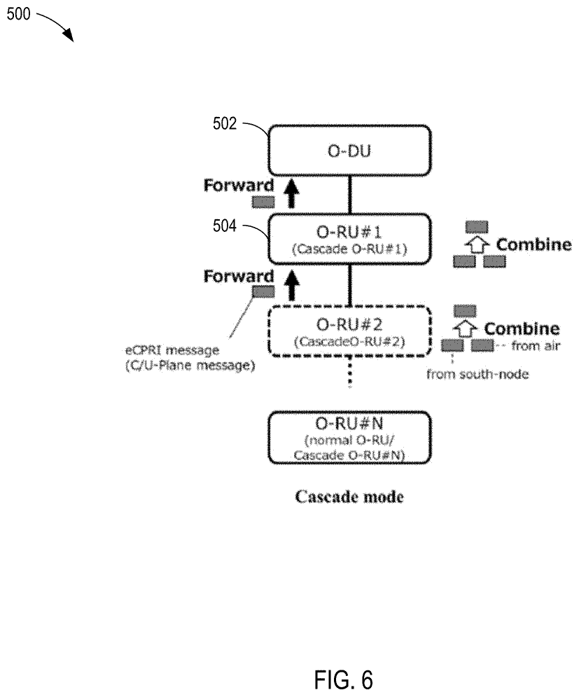

FIG. 6 is an illustration of uplink flow of the second conventional network cell 500 of FIG. 5 in cascade mode. In example operation, a south-most one of the O-RUs 504 may output an eCPRI message from UE to a northern one of the O-RUs 504, such as O-RU #2 as identified in FIG. 6. O-RU #2 may receive a radio signal from the UE and combine data corresponding to the radio signal with the received eCPRI message to generate a combined eCPRI message. O-RU #2 may forward the combined eCPRI message to O-RU #1, which may combine data received by antenna(s) of RU #2 from the UE with the combined eCPRI message to generate another combined eCPRI message, which may be forwarded to the O-DU 502. In some examples, the arrangement of the O-RUs 504 of FIGS. 5 and 6 in cascade mode may reduce resiliency of the second conventional network cell 500 because a failure in any one of the O-RUs 504 may disconnect one(s) of the O-RU 504 south of the failed node from nodes north of the failed node. In some examples, the arrangement of the O-RUs 504 of FIGS. 5 and 6 in cascade mode may cause increased noise floors and thereby decrease SNR in the signal chain. For example, during UL operation, the noise floor for the RUs 504 may rise due to the multiple stages of combining of signals, such as combining signals received from a south-node with signals received at a north-node at each layer of the cascade chain.

In some examples, the arrangement of the O-RUs 504 of FIGS. 5 and 6 in cascade mode may reduce performance of the second conventional network cell 500. For example, the multiple rounds of transmitting data from a first RU to a second RU, receiving data at the second RU, combining the data at the second RU, and transmitting the combined data to a third RU may add latency to the second conventional network cell 500 when compared to an implementation that includes direct connection(s) between the O-DU 502 and respective ones of the O-RUs 504. In some examples, the multiple rounds of combining data at the various layers of the cascade arrangement may degrade signal quality by performing additional data compression and/or decompression. For example, during UL operation, the noise floor for the RUs 504 may rise due to the multiple stages of combining of signals, such as combining signals received from a south-node with signals received at a north-node at each layer of the cascade chain.

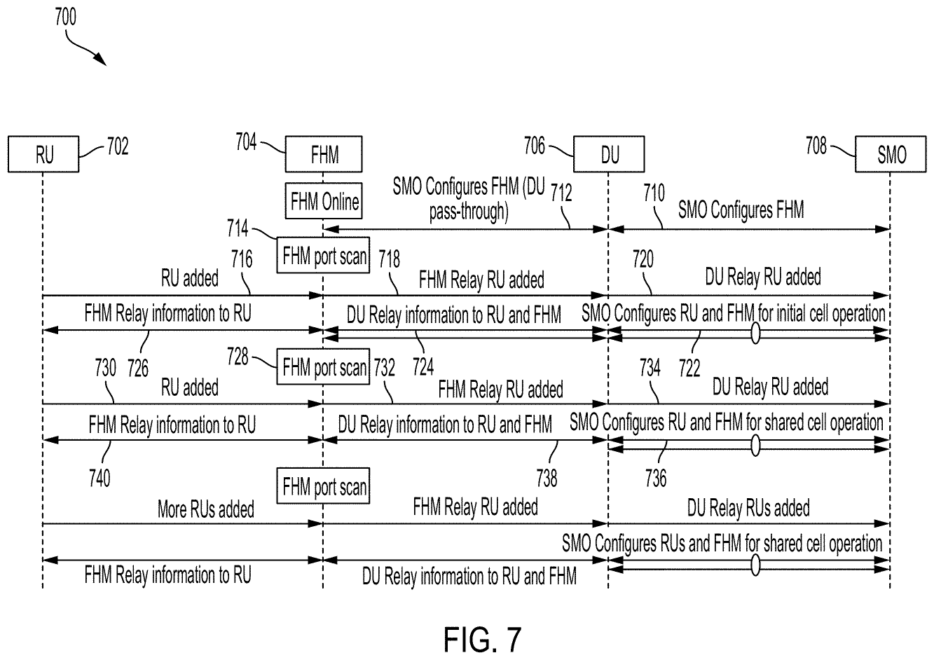

FIG. 7 is a data flow diagram 700 of configuring a conventional cellular network for shared cell operation. The data flow diagram 700 includes one or more RUs 702, a front-haul multiplexer (FHM), a DU 706, and a Service Management and Orchestration (SMO) platform 708 (or simply, the “SMO”). At a first operation 710, after the FHM 704 enters an online state, the SMO 708 transmits configuration data to the DU 706, which is passed through to the FHM 704 at a second operation 712. The configuration data may configure the FHM 704 for shared cell operation.

At a third operation 714, the FHM 704 performs a port scan. For example, the FHM 704 may scan ports (e.g., physical ports, virtual ports, etc.), such as Ethernet ports, of the FHM 704 to determine whether an RU has been added. At a fourth operation 716, the FHM 704 determines that one of the RUs 702 has been added to the cellular network and is in communication with the FHM 704 via one of the scanned ports. At fifth and sixth operations 718, 720 the FHM 704 relays to the SMO 708 via the DU 706 that the RU 702 has been added to the cellular network. At a seventh operation 722, the SMO 708 configures the RU 702 and the FHM 704 for initial cell operation, such as by initializing a first cell of the cellular network to cause the RU 702, the FHM 704, and the DU 706 to communicate with each other. At eighth and ninth operations 724, 726 the DU 706 relays the configuration information from the SMO 708 to the FHM 704 and to the RU 702 via the FHM 704.

At a tenth operation 728, the FHM 704 executes another port scan operation. After the port scan, the FHM 704 determines that another one of the RUs 702 has been added at an eleventh operation 730. At twelfth and thirteenth operations 732, 734 the FHM 704 relays information to the SMO 708 via the DU 706 indicative of the RU addition to the cellular network. In response to determining that another RU has been added, the SMO 708 configures the added RU and the FHM 704 for shared cell operation. For example, at fourteenth through sixteenth operations 736, 738, 740 the SMO 708 may transmit configuration data to the FHM 704 (via the DU 706) and to the RU 702 (via the DU 706 and the FHM 704). After the RU 702 and the FHM 704 are configured based on the configuration data, the RU 702 and the FHM 704 are configured for shared cell operation. The data flow diagram 700 of FIG. 7 is depicted as adding more RUs for shared cell operation based on repeating the tenth through sixteenth operations 728, 730, 732, 734, 736, 738, 740.

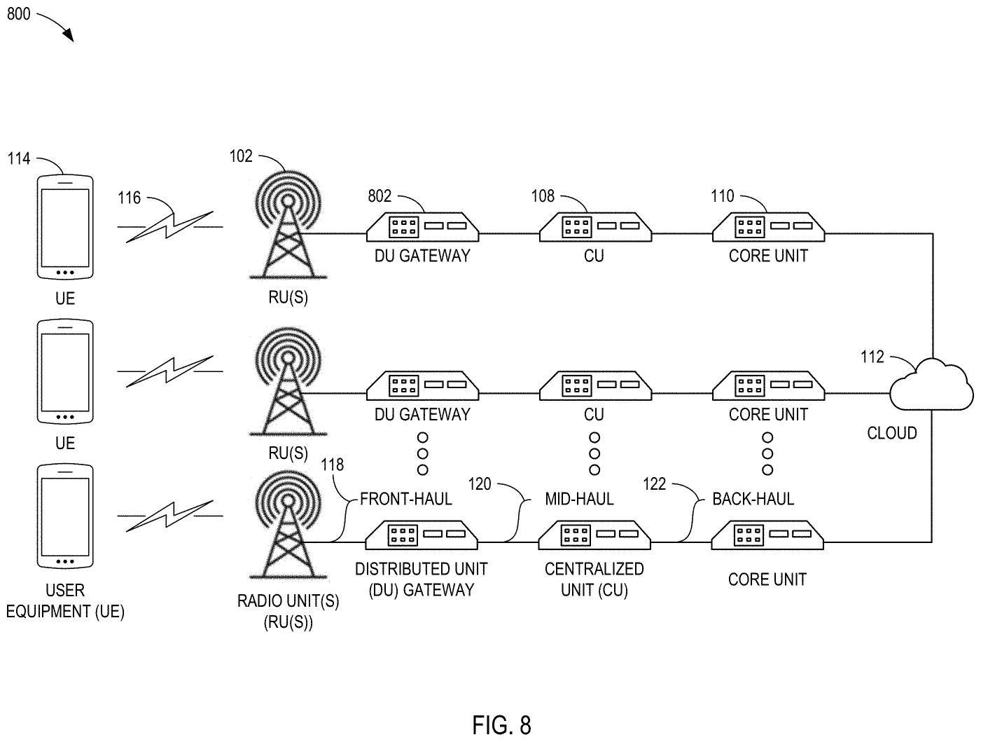

FIG. 8 is an illustration of an example implementation of a cellular network 800 that includes an example distributed unit (DU) gateway 802 as part of a front-haul network, such as the front-haul portion 118 of FIG. 1. The cellular network 800 of the illustrated example includes the UE 114, the communication links 116, the RUs 102, the CUs 108, the core units 110, the cloud 112, the front-haul portion 118, the mid-haul portion 120, and the back-haul portion 122 of FIG. 1.

The DU gateways 802 are logical nodes that may host switch functions, gateway functions, and baseband functions. For example, the DU gateways 802 may implement switches, such as Ethernet-based switches, to route data between portions of the cellular network 800. In some examples, the DU gateways 802 may host switch functions, such as front-haul switch functions, to implement accurate time and frequency synchronization among the RUs 102 and the DU gateways 802. For example, the DU gateways 802 may host time/synchronization functions as the Institute of Electrical and Electronics Engineers (IEEE) 1588 Precision Time Protocol, over the front-haul portion 118 to synchronize the RUs 102 and the DU gateways 802. In some examples, the DU gateways 802 may host switch functions such as Telecom-Boundary Clock (T-BC) when multiple ones of the RUs 102 are connected to one of the DU gateways 802.

In some examples, the DU gateways 802 host gateway functions, such as a front-haul gateway (FHGW or FHG) functions, to move traffic between the RUs 102 and the DU gateways 802 when protocol translation is to be supported. In some examples, the DU gateways 802 host FHM functions, such as DL copy functions (e.g., DL copy and forward functions), UL aggregation functions (e.g., UL combine and forward functions), noise suppression functions, etc., and/or any combination(s) thereof.

In some examples, the DU gateways 802 are baseband gateways because they may host, execute, and/or perform baseband processing functions. For example, the DU gateways 802 may host baseband processing functions, such as high-PHY, RLC, and/or MAC processing based on a lower layer functional split, such as Split Architecture Option 7-2x as specified by O-RAN Control, User and Synchronization Plane Specification 10.0 (e.g., O-RAN Alliance Specification O-RAN.WG4.CUS.0-v10.00 or later). The DU gateways 802 may be implemented by hardware alone, or may be implemented by a combination of hardware, software, and/or firmware.

In example operation, the UE 114 transmit radio signals representative of wireless data, such as cellular data, to the RUs 102 via the communication links 116. The RUs 102 may output the wireless data to a corresponding one of the DU gateways 802. The DU gateways 802 may execute decompression functions on the wireless data from the RUs 102 to generate decompressed data. For example, the RUs 102 may convert the received radio signals to digitized in-phase/quadrature-phase (I/Q) samples, compress the I/Q samples to generate compressed I/Q samples, and output the compressed I/Q samples to the DU gateways 802. The DU gateways 802 may receive the compressed I/Q samples, decompress the I/Q samples, combine one(s) of the I/Q samples that correspond to the same radio resource element (e.g., the same one of the RUs 102), and output the combined decompressed I/Q samples to a DU instance.

In example operation, the DU instance may host, execute, and/or perform baseband functions on the combined decompressed I/Q samples to generate processed baseband data. The DU instance may output the processed baseband data (e.g., via a network interface) to one of the CUs 108 via the mid-haul portion 120. In example operation, the CUs 108 may further process the baseband data and facilitate transmission of the baseband data to the core units 110 and/or the cloud 112. For example, the core units 110 and/or the cloud 112 may execute an application (e.g., a software application, a cellular network application, etc.) to control, manage, and/or operate the cellular network 800 of FIG. 8 based on the baseband data.

Advantageously, the DU gateways 802 provide improvements in system performance of the cellular network 800 with respect to the cellular network 100 of FIG. 1. For example, the DU gateways 802 may eliminate standalone front-haul hardware, such as front-haul Ethernet switches, FHGs (or FHGWs), FHMs, etc. In some examples, the DU gateways 802 may implement front-haul switch, gateway, and/or FHM functions in a single, physical hardware unit. Advantageously, the single, physical hardware unit may eliminate extraneous network interfaces, which may reduce latency, increase throughput, and/or increase bandwidth of the DU gateways 802, and/or, more generally, the cellular network 800 of FIG. 8.

In some examples, the DU gateways 802 may include, execute, and/or instantiate multiple DU instances that can support multiple cells (e.g., network cells). For example, the DU gateways 802 may host a gateway function to process and route signals to/from multiple ones of the RUs 102 and host the multiple DU instances to process the signals from the multiple ones of the RUs 102. Advantageously, the execution of multiple DU instances to support multiple cells may eliminate non-advantageous architectures, such as one(s) of the RUs 102 in a cascade-chain arrangement. For example, the elimination of the need for cascade-chain RU architectures may improve network resiliency because if one of the RUs 102 of FIG. 8 fails and/or otherwise becomes non-responsive, offline, etc., the remaining portions of the cellular network 800 continue to operate as anticipated.

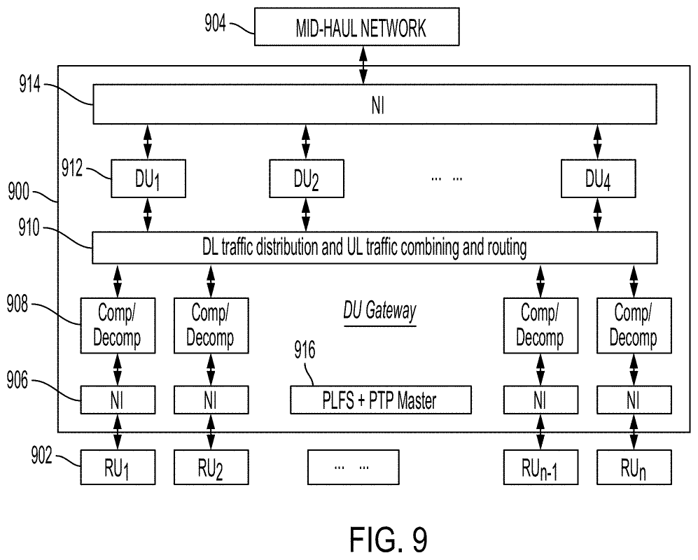

FIG. 9 is a block diagram of an example implementation of a DU gateway 900 connected to RUs 902 and a mid-haul network 904. For example, the DU gateways 802 of FIG. 8 may be implemented by the DU gateway 900 of FIG. 9. The RUs 102 of FIG. 8 may be implemented by the RUs 902 of FIG. 9. The mid-haul portion 120 of FIG. 8 may be implemented by the mid-haul network 904 of FIG. 9.

In some examples, the DU gateway 900 of FIG. 9 may be a baseband gateway because it may host, execute, and/or perform baseband processing functions. The DU gateway 900 may host communication functions to facilitate the flow of data traffic in a wireless network, such as the cellular network 800 of FIG. 8. The DU gateway 900 includes first network interfaces (NIs) 906, compression/decompression (COMP/DECOMP) functions 908, a downlink (DL) traffic distribution and uplink (UL) traffic combining and routing function 910, DU instances 912, a second NI 914, and Physical Layer Frequency Signal (PLFS) protocol and Precision Time Protocol (PTP) protocol functions 916. The PLFS and PTP protocol functions 916 in this example may synchronize one(s) of the RUs 902 with the DU gateway 900 using PLFS and PTP. For example, the DU gateway 900 may be a PTP master that controls and/or manages the synchronization operations.

In some examples, the first NIs 906 are directly coupled to respective ones of the RUs 902. For example, a first one of the first NIs 906 may be in direct communication with a first one of the RUs 902 (identified by RU₁) via an electrical cable (e.g., an Ethernet cable, an optical fiber cable, etc.) with no intermediary devices (e.g., gateway(s), router(s), switch(es), etc.) between the first one of the first NIs 906 and RU₁. In some examples, the first one of the first NIs 906 may be in communication with respective ones of the RUs 902 via one or more intermediary connections, devices, etc. For example, the first one of the first NIs 906 may be in communication with RU₁ via one or more gateways, routers, switches, etc., and/or any combination(s) thereof.

The first NIs 906 in this example receive data (e.g., baseband data, wireless data, RF data, etc.) from and/or transmit data (e.g., baseband data, wireless data, RF data, etc.) to a respective one of the RUs 902. The comp/decomp functions 908 may decompress the received data to generate decompressed data. For example, the comp/decomp functions 908 may decompress data received from the RUs 902 via any type of decompression technique, such as block floating point decompression, block scaling decompression, p-Law decompression, beamspace decompression, modulation decompression, and/or the like. The comp/decomp functions 908 may output the decompressed data to the DL traffic distribution and UL traffic combining and routing function 210.

In some examples, the DU gateway 900 may perform individual processing on the decompressed data prior to the DL traffic distribution and UL traffic combining and routing function 210 receiving the decompressed data. For example, the comp/decomp functions 908 or different logic (e.g., hardware logic alone, or a combination of hardware logic, software logic, and/or firmware logic) may execute noise suppression, noise reduction, etc., on signals representative of the decompressed data to reduce the noise floor associated with the signals, and/or, more generally, the decompressed data. In some examples, the noise floor may be representative of a measure of the noise density, which may be measured in decibel-milliwatts per hertz (dbm/Hz). In some examples, the noise floor may be representative of a measure of the noise power in a signal of 1 hertz (Hz) bandwidth. For example, the noise floor may be a measure of a signal created from a sum of all the noise sources and unwanted signals within the DU gateway 900, or portion(s) thereof, where noise may be specified as any signal other than the one being analyzed, monitored, and/or otherwise processed.

When the DU gateway 900 handles UL traffic, such as when the first NIs 906 receive data from the RUs 902, the DL traffic distribution and UL traffic combining and routing function 910 combines data received by one or more of the first NIs 906 and routes the combined data to one or more of the DU instances 912. In this example, the DU instances 912 may perform baseband processing functions, such as high-PHY, MAC, and/or RLC functions. In some examples, the DU instances 912 are implemented by virtualizations of physical hardware resources. For example, the DU instances 912 may be implemented by virtual machines (VMs), containers, etc., and/or any combination(s) thereof, that is/are instantiated by one or more programmable processors, memories, mass storage disks or devices, etc., of the DU gateway 900. Additionally or alternatively, the DU instances 912 may be implemented by multi-core programmable processors. For example, one or more first cores of a multi-core CPU may implement a first one of the DU instances 912, one or more second cores of the multi-core CPU may implement a second one of the DU instances 912, and so forth. Additionally or alternatively, the DU instances 912 may be implemented by hardware alone, such as hardware-implemented state machines, Application Specific Integrated Circuits (ASICs), etc., and/or any combination(s) thereof.

When the DU gateway 900 handles DL traffic, such as when the second NI 914 receives network data from the mid-haul network 904, the second NI 914 outputs the network data to one(s) of the DU instances 912 for processing. For example, the one(s) of the DU instances 912 may perform baseband processing on the network data to generate baseband processed data. The one(s) of the DU instances 912 may output the baseband processed data to the DL traffic distribution and UL traffic combining and routing function 910. The DL traffic distribution and UL traffic combining and routing function 910 distributes the baseband processed data to the RUs 902 along respective network paths. For example, a first network path may include a first one of the comp/decomp functions 908 and a first one of the first NIs 906 communicatively coupled to the first one of the comp/decomp functions 908.

In some examples, the DL traffic distribution and UL traffic combining and routing function 910 distributes an entirety of the baseband processed data. For example, the DL traffic distribution and UL traffic combining and routing function 910 may make copies of the baseband processed data and distribute the copies along network paths(s) of the DU gateway 900. In some examples, the DL traffic distribution and UL traffic combining and routing function 910 may make copies of portion(s) of the baseband processed data, such as a payload of the baseband processed data, and distribute copies of the payloads along network path(s) of the DU gateway 900.

After receiving baseband processed data from the DL traffic distribution and UL traffic combining and routing function 910, the first one of the comp/decomp functions 908 may compress the baseband processed data to generate compressed data (e.g., compressed baseband data). For example, the comp/decomp functions 908 may compress the baseband processed data via any type of compression technique, such as block floating point compression, block scaling compression, p-Law compression, beamspace compression, modulation compression, and/or the like.

In some examples, the DU gateway 900 may determine a location of UE based on wireless data received from the RUs 902. For example, UE may be in communication with a first one of the RUs 902 (identified by RU₁). The UE may transmit wireless data to RU₁. RU₁ may determine that the UE is connected to the RU₁ based on the wireless data (e.g., identification data in the wireless data that identifies the UE). RU₁ may output the wireless data and/or the identification of the UE being connected to RU₁ to a first one of the NIs 906.

A first one of the DU instances 912 (identified by DU₁) may obtain the wireless data and/or the identification from the first one of the NIs 906 via a first one of the comp/decomp functions 908 and the DL traffic distribution and UL traffic combining and routing function 910. DU₁ may perform UE location processing on the wireless data and/or the identification. DU₁ may identify a location of the UE based on at least one of (i) the identification that the UE is connected to RU₁, (ii) a known location of RU₁, or (iii) UE location processed data such as time-of-arrival (TOA) data, time-difference-of-arrival (TDOA) data, angle-of-arrival (AOA) data, etc. For example, the wireless data output from RU₁ may include AOA data associated with an angle at which RF signals from the UE is received by one or more antennas of RU₁. In some examples, the wireless data output from RU₁ may include TOA data, TDOA data, etc., associated with a first time at which RU₁ transmits a position reference signal to the UE and/or a second time at which RU₁ receives a return position reference signal from the UE.

In some examples, DU₁ may output the location of the UE to an upper application layer, such as an SMO associated with the mid-haul network 904. For example, an application (e.g., a software application, a cloud-based application, etc.) that uses UE locations as data inputs to generate data outputs, may request the DU instances 912 for UE locations on an aperiodic or periodic basis. In response to the request(s), the DU instances 912 may determine the UE locations and output the determined UE locations to the requestor(s).

Advantageously, the DU gateway 900 may reduce latency in a cellular network, such as the cellular network 800 of FIG. 8. For example, the DU gateway 900 may eliminate the decomp/comp functions 212 and the second NIs 214 of FIG. 2 by integrating the DU instances 912 in the DU gateway 900. By reducing the number of times data (e.g., wireless data, network data, etc.) is compressed and/or decompressed, the latency associated with processing the data is decreased and thereby improves the performance of the cellular network. Advantageously, by reducing the number of times data is compressed and/or decompressed, the signal quality may be improved. For example, data processed by the DU gateway 900 may have a first signal quality greater than a second signal quality of data processed by the FHM 200 of FIG. 2.

In some examples, the DU gateway 900 may perform noise suppression functions to prevent noise floor rise and thusly improve signal quality of data processed by the DU gateway 900. For example, the first NIs 906, the comp/decomp functions 908, and/or the DL traffic distribution and UL traffic combining and routing function 910 may perform the noise suppression functions. In some examples, the DU gateway 900 may perform noise suppression functions as the number of the RUs 902 connected to the DU gateway 900 increase. In some examples, the DU gateway 900 may disable the noise suppression functions to conserve hardware resources (e.g., compute, memory, etc., resources) and/or power when the number of the RUs 902 is below a threshold. In some examples, the DU gateway 900 may enable the noise suppression functions when the number of the RUs 902 meets and/or is greater than the threshold.

Advantageously, the DU gateway 900 may improve cellular network deployment flexibility. For example, the DU gateway 900 may eliminate the need for a cascade chain arrangement of the RUs 902 because the RUs 902 may be directly connected to the DU gateway 900. In such an example, the DL traffic distribution and UL traffic combining and routing function 910 may perform the DL copy function as described above in connection with FIGS. 3 and 5 and perform the UL combine function as described above in connection with FIGS. 4 and 6. Thusly, the DU gateway 900 may be connected (e.g., directly connected) to one or more of the RUs 902 and shift the copy and combining functions from the RUs 902 to the DU gateway 900 for improved processing efficiency and reduced latency.

While an example implementation of the DU gateway 900 is depicted in FIG. 9, other implementations are contemplated. For example, one or more blocks, components, functions, etc., of the DU gateway 900 may be combined or divided in any other way. The DU gateway 900 of the illustrated example may be implemented by hardware alone, or by a combination of hardware, software, and/or firmware. For example, the DU gateway 900 may be implemented by one or more analog or digital circuits (e.g., comparators, operational amplifiers, etc.), one or more hardware-implemented state machines, one or more programmable processors (e.g., central processing units (CPUs), digital signal processors (DSPs), field programmable gate arrays (FPGAs), etc.), one or more network interfaces (e.g., network interface circuitry, network interface cards (NICs), smart NICs, etc.), one or more ASICs, one or more memories (e.g., non-volatile memory, volatile memory, etc.), one or more mass storage disks or devices (e.g., hard-disk drives (HDDs), solid-state disk (SSD) drives, etc.), etc., and/or any combination(s) thereof. The DU gateway 900 of the illustrated example is implemented as a single, physical hardware device, such as being in the same electrical enclosure, housing, etc. Alternatively, one or more portions of the DU gateway 900 may be implemented as two or more separate physical hardware devices.

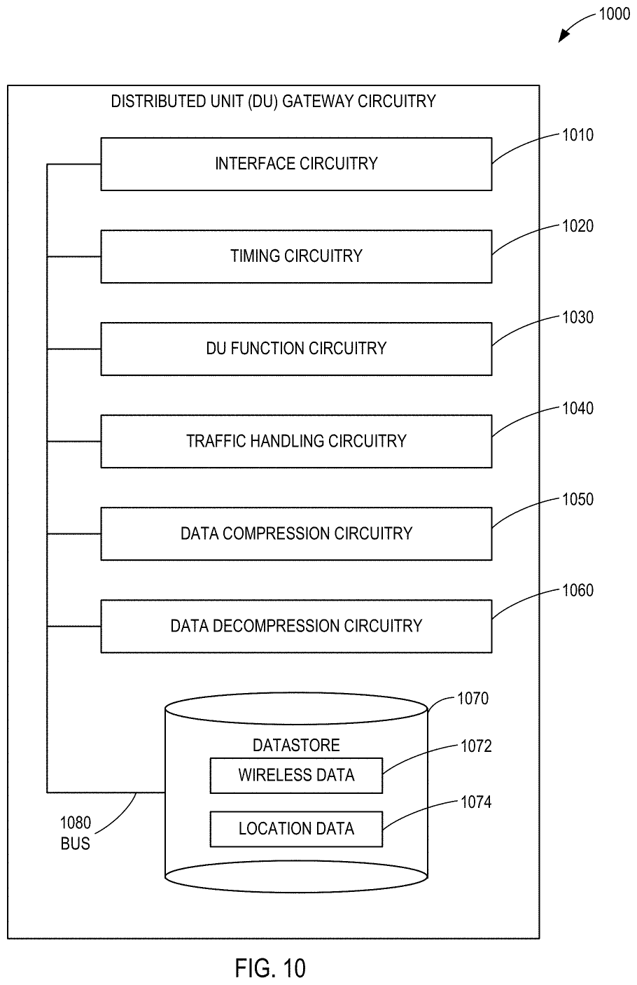

FIG. 10 is a block diagram of an example implementation of DU gateway circuitry 1000. For example, the DU gateways 802 of FIG. 8 may be implemented by the DU gateway circuitry 1000. In some examples, the DU gateway 900 of FIG. 9 may be implemented by the DU gateway circuitry 1000 of FIG. 10. In some examples, the DU gateway circuitry 1000 may be baseband gateway circuitry because it, or portion(s) thereof, may host, execute, and/or perform baseband processing functions.

The DU gateway circuitry 1000 of FIG. 10 includes interface circuitry 1010, timing circuitry 1020, DU function circuitry 1030, traffic handling circuitry 1040, data compression circuitry 1050, data decompression circuitry 1060, and a datastore 1070. In the illustrated example, one(s) of the interface circuitry 1010, the timing circuitry 1020, the distributed unit function circuitry 1030, the traffic handling circuitry 1040, the data compression circuitry 1050, the data decompression circuitry 1060, and the datastore 1070 may be in communication with one(s) of each other via a bus 1080. The bus 1080 may be any type of computing and/or electrical bus, such as an Inter-Integrated Circuit (I2C) bus, a Peripheral Component Interconnect (PCI) bus, a Peripheral Component Interconnect Express (PCIe) bus, a Serial Peripheral Interface (SPI) bus, and/or the like.

The DU gateway circuitry 1000 includes the interface circuitry 1010 to receive and/or transmit data to a logical node, such as an RU, a CU, etc. In some examples, the first NIs 906 and/or the second NI 914 of FIG. 9 may be implemented by the interface circuitry 1010.

In some examples, the interface circuitry 1010 may transmit (or cause transmission of) data (e.g., baseband data, wireless data, etc.) to the RUs 102 of FIG. 8. In some examples, the interface circuitry 1010 may receive data (e.g., baseband data, wireless data, etc.) from the RUs 102 of FIG. 8. In some examples, the transmitted data and/or the received data is compressed data. In some examples, the interface circuitry 1010 determines whether to continue obtaining wireless data from an RU.

In some examples, the interface circuitry 1010 receives and/or transmit data to a network, such as a mid-haul network. For example, the interface circuitry 1010 may transmit (or cause transmission of) data (e.g., baseband processed data, network data, etc.) to the CUs 108 of FIG. 8, and/or, more generally, the mid-haul portion 120 of FIG. 8. In some examples, the interface circuitry 1010 may receive data (e.g., network data, configuration data, data representative of a firmware executable, data representative of a software executable, etc.) from the CUs 108, the core units 110, the cloud 112, and/or the mid-haul portion 120 of FIG. 8. In some examples, the interface circuitry 1010 determines whether to continue obtaining network data from a network.

In some examples, the interface circuitry 1010 scans network ports for active RUs. For example, the interface circuitry 1010 may scan a plurality of network ports (e.g., physical ports, virtual ports, virtualizations of physical ports, etc.), such as Ethernet ports, to determine whether one(s) of the RUs 102 of FIG. 8 is/are in communication with the interface circuitry 1010. The interface circuitry 1010 may determine that a new RU has been added based on the scanning. In some examples, the interface circuitry 1010 may determine that the identified RU is to be added to an existing network cell. In some examples, after the determination that the RU is to be added to an existing network cell, the interface circuitry 1010 may instruct a DU instance implemented by the DU function circuitry 1030 to configure the RU to be associated with the existing network cell. In some examples, the interface circuitry 1010 determines whether to continue scanning the network ports for active RUs.

In some examples, the interface circuitry 1010 may request an electronic device, such as a server, for machine-readable instructions to adjust, change, modify, etc., a capability of the DU gateway circuitry 1000. For example, after a determination that the DU gateway circuitry 1000 has exceeded a utilization (e.g., a compute and/or processing utilization, a bandwidth utilization, a throughput utilization, etc.), the interface circuitry 1010 may cause transmission of a request to the cloud 112 of FIG. 8 for machine-readable instructions that, when executed by the DU gateway circuitry 1000, reconfigures the DU gateway circuitry 1000 to operate with reduced utilization. In some examples, the machine-readable instructions may correspond to, be representative of, and/or implement an executable (e.g., an executable file).

In some examples, the interface circuitry 1010 may request an electronic device, such as a server, for machine-readable instructions to improve an accuracy at which the DU gateway circuitry 1000 determines a location of UE. For example, after a determination that the DU gateway circuitry 1000 determines a location of UE with an accuracy that falls beneath a threshold (e.g., an accuracy threshold), the interface circuitry 1010 may cause transmission of a request to the cloud 112 of FIG. 8 for machine-readable instructions that, when executed by the DU gateway circuitry 1000, reconfigures the DU gateway circuitry 1000 to determine the UE location with increased accuracy. In some examples, the machine-readable instructions may correspond to, be representative of, and/or implement an executable (e.g., an executable file).

The DU gateway circuitry 1000 includes the timing circuitry 1020 to handle, manage, and/or synchronize timing of multiple electronic devices, logical nodes of a cellular network, etc. In some examples, the PLFS and PTP protocol functions 916 of FIG. 9 may be implemented by the timing circuitry 1020. For example, the timing circuitry 1020 may execute the PLFS and PTP protocol functions 916 of FIG. 9 to synchronize one(s) of the RUs 102 of FIG. 8 with the DU gateway circuitry 1000 using PLFS and PTP. For example, the timing circuitry 1020 may implement and/or host a PTP master that controls and/or manages the synchronization operations.

The DU gateway circuitry 1000 includes the DU function circuitry 1030 to perform baseband processing on data (e.g., compressed data, decompressed data, network data, wireless data, etc.) to generate baseband processed data. In some examples, the DU instances 912 of FIG. 9 may be implemented by the DU function circuitry 1030. In some examples, the DU function circuitry 1030 may execute baseband functions such as high-PHY, MAC, and/or RLC functions. For example, the DU function circuitry 1030 may execute Layer 1 (L1) functions, such as high-PHY functions, which may include resource element (RE) mapping functions, RE de-mapping functions, channel estimation functions, indirect forwarding tunnel (IDFT) channel estimation functions, equalization functions, detection functions, modulation functions, demodulation functions, scrambling functions, descrambling functions, precoding functions, bit level processing functions, and/or the like. In some examples, the DU function circuitry 1030 may execute Layer 2 (L2) functions, such as MAC functions, RLC functions, PDCP functions, and/or the like. For example, the DU function circuitry 1030 may perform L1 processing and/or L2 processing on network data to generate baseband processed data. In some examples, the DU function circuitry 1030 may perform L1 processing and/or L2 processing on decompressed data to generate decompressed baseband data.

In some examples, the DU function circuitry 1030 may instantiate a network cell for single cell operation or shared cell operation. For example, the DU function circuitry 1030 may instantiate a DU instance, such as one of the DU instances 912 of FIG. 9, to be associated with a network cell, configure one(s) of the RUs 102 of FIG. 8 to be associated with the network cell, and control operation of the network cell.

In some examples, the DU function circuitry 1030 determines that the DU gateway circuitry 1000 is to adjust, change, modify, etc., an existing capability of the DU gateway circuitry 1000. For example, the DU function circuitry 1030 may process wireless data associated with a device, such as one of the UE 114 of FIG. 8. The DU function circuitry 1030 may determine a location of the device based on the wireless data, an identification of the UE being associated with one of the RUs 102 that received the wireless data, etc., and/or any combination(s) thereof. The DU function circuitry 1030 may determine that an accuracy of the location falls beneath a threshold (e.g., an accuracy threshold). In response to the determination, the DU function circuitry 1030 may direct the interface circuitry 1010 to request machine-readable instructions that, when executed by the DU function circuitry 1030, may cause the DU function circuitry 1030 to determine subsequent locations of the UE with increased accuracy that may meet and/or be greater than the threshold. In some examples, the DU function circuitry 1030 may determine whether to continue monitoring for location accuracy.

In some examples, the DU function circuitry 1030 determines that the DU gateway circuitry 1000 is to operate with a new capability. For example, the DU function circuitry 1030 may enable distributed multi-user, multiple-input, multiple-output (distributed MU-MIMO) for higher capacity, reduced utilization, etc. In some examples, the DU function circuitry 1030 may enable multi transmission and reception point (Multi-TRP) to enhance ultra-reliable, low-latency communications (URLLC) support for cellular edge users. For example, the DU function circuitry 1030 may instruct the interface circuitry 1010 to request machine-readable instructions that, when executed by the DU function circuitry 1030, may enable distributed MU-MIMO, Multi-TRP, etc.

The DU gateway circuitry 1000 includes the traffic handling circuitry 1040 to execute copy and/or combine functions. In some examples, the DL traffic distribution and UL traffic combining and routing function 910 of FIG. 9 may be implemented by the traffic handling circuitry 1040. In some examples, the traffic handling circuitry 1040 may execute a copy function, such as a DL copy function, on flows of DL traffic (e.g., from the DU instances 912, the DU function circuitry 1030, etc.). For example, the interface circuitry 1010 may receive network data, such as Ethernet frames with payloads that include eCPRI messages, from the DU function circuitry 1030. In some examples, the traffic handling circuitry 1040 may copy an entirety of the eCPRI messages, or portion(s) thereof (e.g., the eCPRI headers, the eCPRI payloads, etc.), without any modifications as payload into Ethernet frames and send the Ethernet frames to one(s) of the RUs 102 of FIG. 8. For example, the DU gateway 802 may send copies of the eCPRI messages as Ethernet frames to one or more of the RUs 102.

In some examples, the traffic handling circuitry 1040 may execute a combine function, such as a UL combine function, on flows of UL traffic (e.g., from the RU(s) 902, from the interface circuitry 1010, etc.). For example, the traffic handling circuitry 1040 may obtain multiple eCPRI messages, such as eCPRI messages in the payloads of Ethernet frames, from a first RU of the RUs 102 and a second RU of the RUs 102. The eCPRI messages may include eCPRI transport header(s), application layer common header(s), and application layer section field(s), each of which may include information elements. The traffic handling circuitry 1040 may identify IQ data corresponding to the same radio resource element from the information elements. For example, for the first RU, the traffic handling circuitry 1040 may obtain compression information associated with the information elements (e.g., if the eCPRI messages were originally compressed), iSample data, and qSample data from eCPRI messages corresponding to the first RU and calculate the combined iSample and qSample by adding iSample and qSample individually and taking compression information into account.

In some examples, the traffic handling circuitry 1040 monitors the DU gateway circuitry 1000, or portion(s) thereof, for changes in capacity (e.g., compute and/or processing capacity, throughput capacity, bandwidth capacity, etc.), utilization (e.g., compute and/or processing utilization, throughput utilization, bandwidth utilization, etc.), etc. For example, after the traffic handling circuitry 1040 determines that the utilization of the DU gateway circuitry 1000, or portion(s) thereof, exceeds a threshold, the traffic handling circuitry 1040 may generate and/or cause transmission of a request for machine-readable instructions that, when executed by the traffic handling circuitry 1040, may decrease the utilization to fall below the threshold. For example, the machine-readable instructions may be representative of distributed MU-MIMO protocol functions to achieve the decrease in utilization, an increase in capacity, etc.

The DU gateway circuitry 1000 includes the data compression circuitry 1050 to compress data to generate compressed data. In some examples, the comp/decomp functions 908 of FIG. 9, or portion(s) thereof, may be implemented by the data compression circuitry 1050. For example, the data compression circuitry 1050 may execute, perform, and/or carry out any compression technique (e.g., data compression technique), such as block floating point compression, block scaling compression, p-Law compression, beamspace compression, modulation compression, and/or the like on data (e.g., decompressed data) to generate compressed data.

The DU gateway circuitry 1000 includes the data decompression circuitry 1060 to decompress data to generate decompressed data. In some examples, the comp/decomp functions 908 of FIG. 9, or portion(s) thereof, may be implemented by the data decompression circuitry 1060. For example, the data decompression circuitry 1060 may execute, perform, and/or carry out any decompression technique (e.g., data decompression technique), such as block floating point decompression, block scaling decompression, p-Law decompression, beamspace decompression, modulation decompression, and/or the like on compressed data to generate decompressed data.

The DU gateway circuitry 1000 includes the datastore 1070 to record data, such as wireless data 1072, location data 1074, etc. In some examples, the wireless data 1072 may be data received by the interface circuitry 1010 from an RU, such as the RUs 102 of FIG. 8, and/or data transmitted by the interface circuitry 1010 to the RU. For example, the wireless data 1072 may be eCPRI messages, Ethernet frames, cellular data, etc. In some examples, the location data 1074 may include first data that identifies UE (e.g., data from the UE that identifies the UE), second data that identifies an RU to which the UE is connected, AOA data, TOA data, TDOA data, etc. In some examples, the location data 1074 may be a geographical distance between UE and a reference point, such as the RU. In some examples, the location data 1074 may be coordinate data, such as Global Positioning System (GPS) data. In some examples, the datastore 1070 is storage that may be implemented by one or more memories (e.g., non-volatile memory, volatile memory, etc.), one or more mass storage disks or devices (e.g., HDDs, SSD drives, etc.), etc., and/or any combination(s) thereof. Although the illustrate example of FIG. 10 depicts the datastore 1070 as a single datastore 1070, any number of datastores may be used.

While an example implementation of the DU gateway circuitry 1000 is depicted in FIG. 10, other implementations are contemplated. For example, one or more blocks, components, functions, etc., of the DU gateway circuitry 1000 may be combined or divided in any other way. The DU gateway circuitry 1000 of the illustrated example may be implemented by hardware alone, or by a combination of hardware, software, and/or firmware. For example, the DU gateway circuitry 1000 may be implemented by one or more analog or digital circuits (e.g., comparators, operational amplifiers, etc.), one or more hardware-implemented state machines, one or more programmable processors (e.g., CPUs, DSPs, FPGAs, etc.), one or more network interfaces (e.g., network interface circuitry, NICs, smart NICs, etc.), one or more ASICs, one or more memories (e.g., non-volatile memory, volatile memory, etc.), one or more mass storage disks or devices (e.g., HDDs, SSD drives, etc.), etc., and/or any combination(s) thereof.

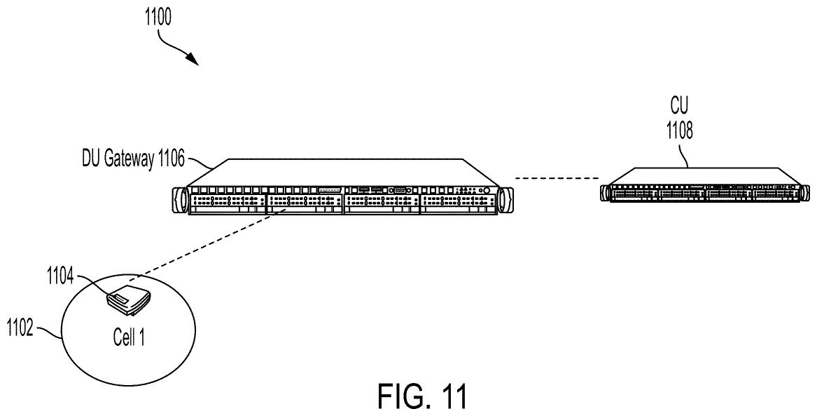

FIG. 11 is a first example network cell configuration 1100 including a single network cell 1102 with a single RU 1104. For example, the first network cell configuration 1100 may implement a cell deployment with a single RU 1104. In the illustrated example, the RU 1104, and/or, more generally, the network cell 1102, is connected to a DU gateway 1106, which is connected to a CU 1108. For example, the RU 1104 may be directly connected to the DU gateway 1106.

The RU 1104 of this example may be implemented by the RUs 102 of FIGS. 1 and/or 8. In this example, the CU 1108 may be implemented by the CUs 108 of FIGS. 1 and/or 8. The DU gateway 1106 of the illustrated example may be implemented by the DU gateways 802, the DU gateway 900 of FIG. 9, and/or the DU gateway circuitry 1000 of FIG. 10. In this example, the DU gateway 1106 is a single, physical hardware device.

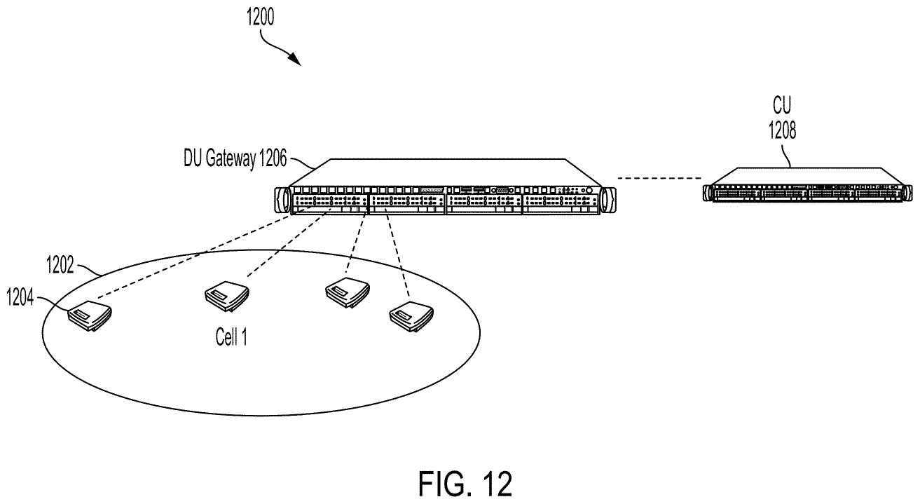

FIG. 12 is a second example network cell configuration 1200 including a single network cell 1202 with a plurality of RUs 1204. For example, the second network cell configuration 1200 may implement a cell deployment within a plurality of RUs 1204. In the illustrated example, the RUs 1204, and/or, more generally, the network cell 1202, is connected to a DU gateway 1206, which is connected to a CU 1208. For example, the RUs 1204 may be directly connected to the DU gateway 1206.

The RUs 1204 of this example may be implemented by the RUs 102 of FIGS. 1 and/or 8. In this example, the CU 1208 may be implemented by the CUs 108 of FIGS. 1 and/or 8. The DU gateway 1206 of the illustrated example may be implemented by the DU gateways 802, the DU gateway 900 of FIG. 9, and/or the DU gateway circuitry 1000 of FIG. 10. In this example, the DU gateway 1206 is a single, physical hardware device.

Advantageously, the DU gateway 1206 may promote network cell configuration flexibility by enabling connections of one or more of the RUs 1204 to the same shared cell 1202 via the DU gateway 1206. For example, the DU gateway 1206 may enable an extension of network coverage with the addition of RU(s) to the network cell 1202. In some examples, the DU gateway 1206 may boost UL signals from the RUs 1204, reduce noise floor, and/or suppress interference on UL data traffic in response to additional ones of the RUs 1204 being added to the network cell 1202.

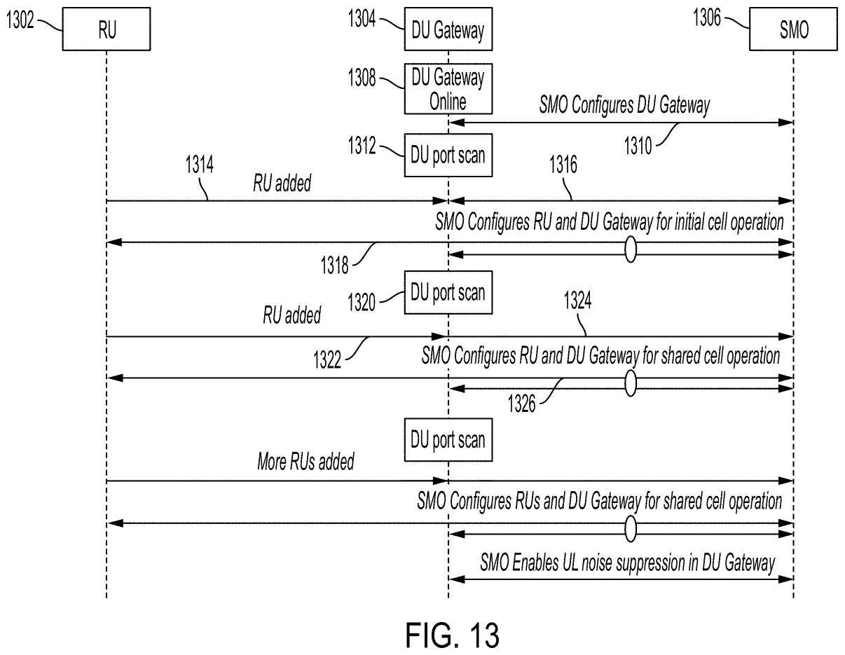

FIG. 13 is a data flow diagram 1300 corresponding to example operation of the second network cell configuration 1200 of FIG. 12. The data flow diagram 1300 of FIG. 13 is implemented by one or more RUs 1302, a DU gateway 1304, and an SMO 1306. For example, the one or more RUs 1302 may be implemented by one(s) of the RUs 102 of FIGS. 1 and/or 8. The DU gateway 1304 in this example may be implemented by the DU gateway 802 of FIG. 8, the DU gateway 900 of FIG. 9, and/or the DU gateway circuitry 1000 of FIG. 10. The SMO 1306 of the illustrated example is an SMO platform.

The data flow diagram 1300 of the illustrated example begins at a first operation 1308 at which the DU gateway 1304 powers on and/or transitions from an offline to an online state. At a second operation 1310, the SMO 1306 configures the DU gateway 1304 for operation in connection with managing and/or operating a network cell for shared cell operation. In response to the configuration, the DU gateway 1304 executes a port scan (e.g., a scan of physical ports, virtual ports, etc.) of the DU gateway 1304 at a third operation 1312. Based on the port scan, the DU gateway 1304 determines that a first RU of the RUs 1302 has been added at a fourth operation 1314. The DU gateway 1304 relays an indication of the addition to the SMO 1306 at a fifth operation 1316.

At a sixth operation 1318 of the data flow diagram 1300, the SMO 1306 configures the first RU and the DU gateway 1304 for initial cell operation, such as initial operation of the network cell 1202 of FIG. 12. At a seventh operation 1320, the DU gateway 1304 performs another port scan of the DU gateway 1304. The DU gateway 1304 determines that a second RU of the RUs 1302 has been added at an eighth operation 1322 and relays the indication of the addition to the SMO 1306 at a ninth operation 1324.

At a tenth operation 1326 of the data flow diagram 1300, the SMO 1306 configures the second RU and the DU gateway 1304 for shared cell operation. For example, the SMO 1306, which may be hosted by the CU 1208 of FIG. 12, may instruct the DU gateway 1206 of FIG. 12 to configure a second one of the RUs 1204 for shared cell operation with the DU gateway 1206. The data flow diagram 1300 of FIG. 13 is depicted as adding more RUs for shared cell operation based on repeating the seventh through tenth operations 1320, 1322, 1324, 1326.

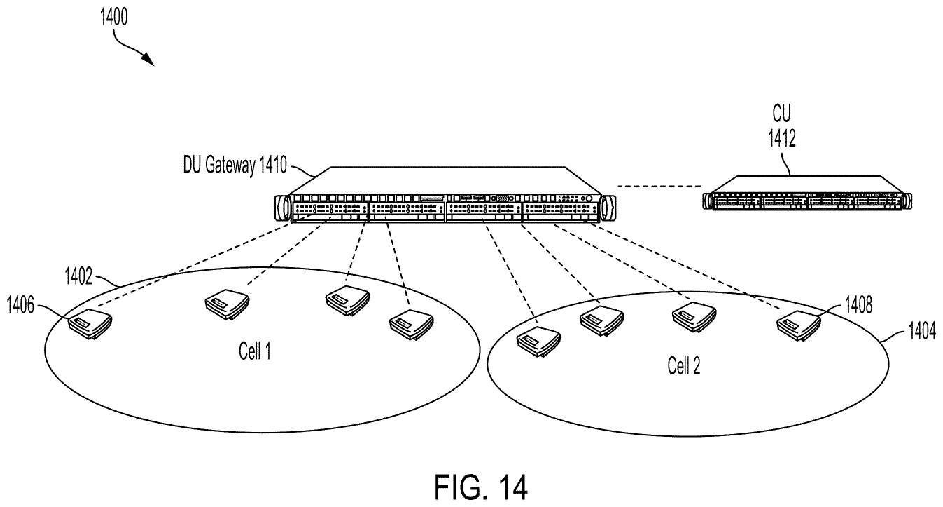

FIG. 14 is a third example network cell configuration 1400 including a first network cell 1402 (identified by CELL 1) and a second network cell 1404 (identified by CELL 2) each with a plurality of RUs 1406, 1408. For example, the third network cell configuration 1400 may implement a multi-cell deployment with a plurality of RUs 1406, 1408. In the illustrated example, the RUs 1406, 1408, and/or, more generally, the network cells 1402, 1404, are respectively connected to a DU gateway 1410, which is connected to a CU 1412. For example, the RUs 1406, 1408 may be respectively and directly connected to the DU gateway 1410.

The RUs 1406, 1408 of this example may be implemented by the RUs 102 of FIGS. 1 and/or 8. In this example, the CU 1412 may be implemented by the CUs 108 of FIGS. 1 and/or 8. The DU gateway 1410 of the illustrated example may be implemented by the DU gateways 802 of FIG. 8, the DU gateway 900 of FIG. 9, and/or the DU gateway circuitry 1000 of FIG. 10. In this example, the DU gateway 1410 is a single, physical hardware device.

Advantageously, the DU gateway 1410 may achieve network cell configuration flexibility by enabling connections of the first RUs 1406 to the same shared cell 1402 and the second RUs 1408 to the same shared cell 1404. For example, the DU gateway 1410 may enable an extension of network coverage with the addition of RU(s) to the first network cell 1402 and/or the second network cell 1404. In some examples, the DU gateway 1410 may boost UL signals from the RUs 1406, 1408, reduce noise floor, and/or suppress interference on UL data traffic in response to additional ones of the RUs 1406, 1408 being added to the network cells 1402, 1404. Advantageously, the third network cell configuration 1400 implemented by the DU gateway 1410 may achieve increased capacity with the instantiation and/or operation of two cells compared to a single cell of the first network cell configuration 1100 and the second network cell configuration 1200.

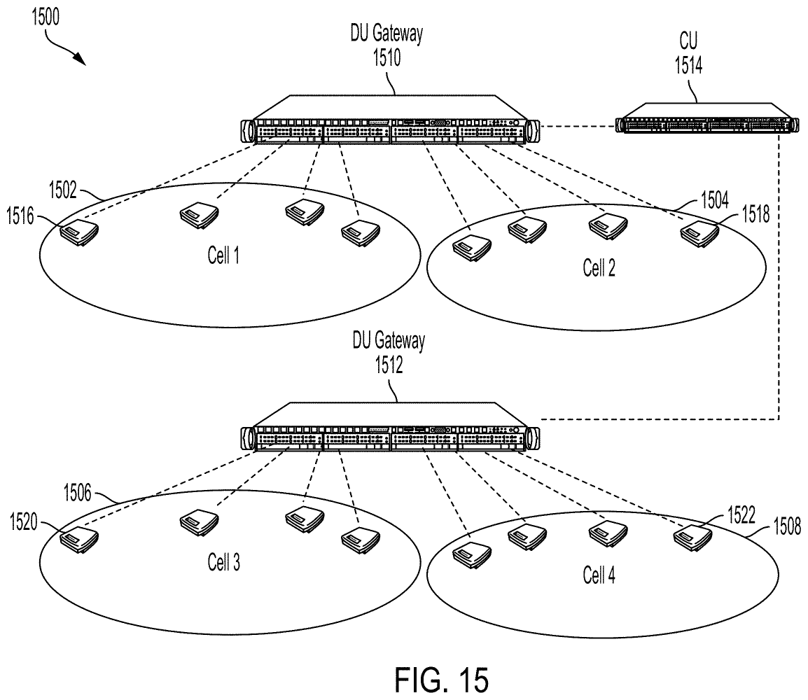

FIG. 15 is a fourth example network cell configuration 1500 including multiple network cells 1502, 1504, 1506, 1508 communicatively and/or physically coupled to DU gateways 1510, 1512. For example, the fourth network cell configuration 1500 may implement a multi-cell deployment. The DU gateways 1510, 1512 are communicatively and/or physically coupled to a CU 1514. RUs 1516, 1518, 1520, 1522 of the network cells 1502, 1504, 1506, 1508 of this example may be implemented by the RUs 102 of FIGS. 1 and/or 8. In this example, the CU 1514 may be implemented by the CUs 108 of FIGS. 1 and/or 8. The DU gateways 1510, 1512 of the illustrated example may be implemented by the DU gateways 802, the DU gateway 900 of FIG. 9, and/or the DU gateway circuitry 1000 of FIG. 10. In this example, the DU gateways 1510, 1512 are respectively implemented by a single, physical hardware device.

The network cells 1502, 1504, 1506, 1508 include a first network cell 1502 (identified by CELL 1), a second network cell 1504 (identified by CELL 2), a third network cell 1506 (identified by CELL 3), and a fourth network cell 1508 (identified by CELL 4), each of which are shared cells. The first network cell 1502 includes a plurality of first RUs 1516 communicatively and/or physically coupled to a first DU gateway 1510 of the DU gateways 1510, 1512. The second network cell 1504 includes a plurality of second RUs 1518 communicatively and/or physically coupled to the first DU gateway 1510. The third network cell 1506 includes a plurality of third RUs 1520 communicatively and/or physically coupled to a second DU gateway 1512 of the DU gateways 1510, 1512. The fourth network cell 1508 includes a plurality of fourth RUs 1522 communicatively and/or physically coupled to the second DU gateway 1512.

Advantageously, the DU gateways 1510, 1512 may achieve network cell configuration flexibility by enabling connections of RUs from different cells to be connected to the same one of the DU gateways 1510, 1512. For example, the DU gateways 1510, 1512 may enable an extension of network coverage with the addition of RU(s) to one or more of the network cells 1502, 1504, 1506, 1508. In some examples, the DU gateways 1510, 1512 may boost UL signals from the RUs 1516, 1518, 1520, 1522, reduce noise floor, and/or suppress interference on UL data traffic in response to additional ones of the RUs 1516, 1518, 1520, 1522 being added to the network cells 1502, 1504, 1506, 1508.

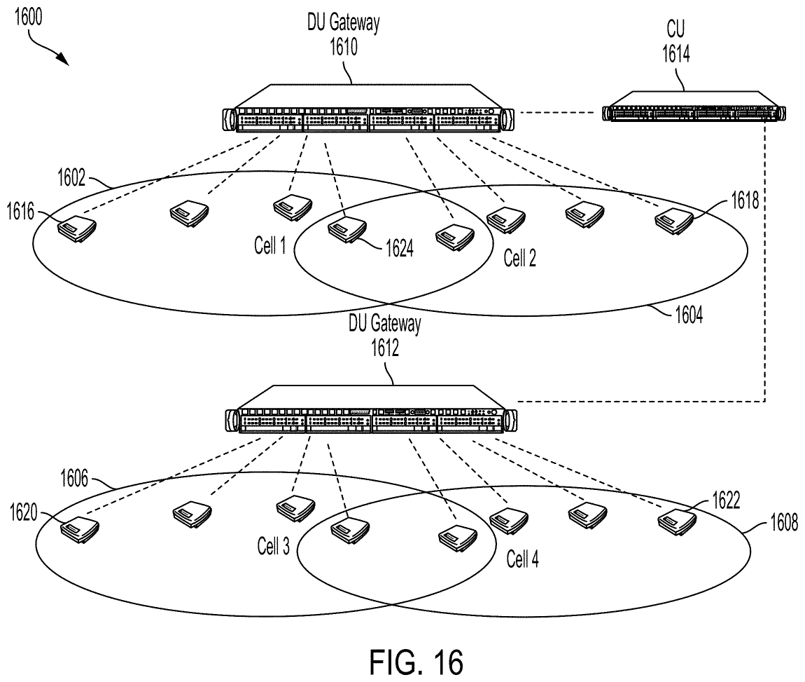

FIG. 16 is a fifth example network cell configuration 1600 including multiple overlapping network cells 1602, 1604, 1606, 1608 communicatively and/or physically coupled to DU gateways 1610, 1612. For example, the fifth network cell configuration 1600 may implement a multi-cell deployment (e.g., an overlapping multi-cell deployment). The DU gateways 1610, 1612 are communicatively and/or physically coupled to a CU 1614. RUs 1616, 1618, 1620, 1622 of the network cells 1602, 1604, 1606, 1608 of this example may be implemented by the RUs 102 of FIGS. 1 and/or 8. In this example, the CU 1614 may be implemented by the CUs 108 of FIGS. 1 and/or 8. The DU gateways 1610, 1612 of the illustrated example may be implemented by the DU gateways 802, the DU gateway 900 of FIG. 9, and/or the DU gateway circuitry 1000 of FIG. 10. In this example, the DU gateways 1610, 1612 are respectively implemented by a single, physical hardware device.

The network cells 1602, 1604, 1606, 1608 include a first network cell 1602 (identified by CELL 1), a second network cell 1604 (identified by CELL 2), a third network cell 1606 (identified by CELL 3), and a fourth network cell 1608 (identified by CELL 4), each of which are shared cells, some of which overlap. The first network cell 1602 includes a plurality of first RUs 1616 communicatively and/or physically coupled to a first DU gateway 1610 of the DU gateways 1610, 1612. The second network cell 1604 includes a plurality of second RUs 1618 communicatively and/or physically coupled to the first DU gateway 1610. The third network cell 1606 includes a plurality of third RUs 1620 communicatively and/or physically coupled to a second DU gateway 1612 of the DU gateways 1610, 1612. The fourth network cell 1608 includes a plurality of fourth RUs 1622 communicatively and/or physically coupled to the second DU gateway 1612.

Advantageously, the DU gateways 1610, 1612 may achieve network cell configuration flexibility by enabling ones of the RUs 1616, 1618, 1620, 1622 to be associated with multiple ones of the network cells 1602, 1604, 1606, 1608. For example, a first RU 1624 of the RUs 1616, 1618, 1620, 1622 is associated with the first network cell 1602 and cooperatively operates with RUs in the second network cell 1604 for Multi-TRP operation. Advantageously, the DU gateways 1610, 1612 may enable an extension of network coverage with the addition of RU(s) to one or more of the network cells 1602, 1604, 1606, 1608. In some examples, the DU gateways 1610, 1612 may boost UL signals from the RUs 1616, 1618, 1620, 1622, reduce noise floor, and/or suppress interference on UL data traffic in response to additional ones of the RUs 1616, 1618, 1620, 1622 being added to the network cells 1602, 1604, 1606, 1608.

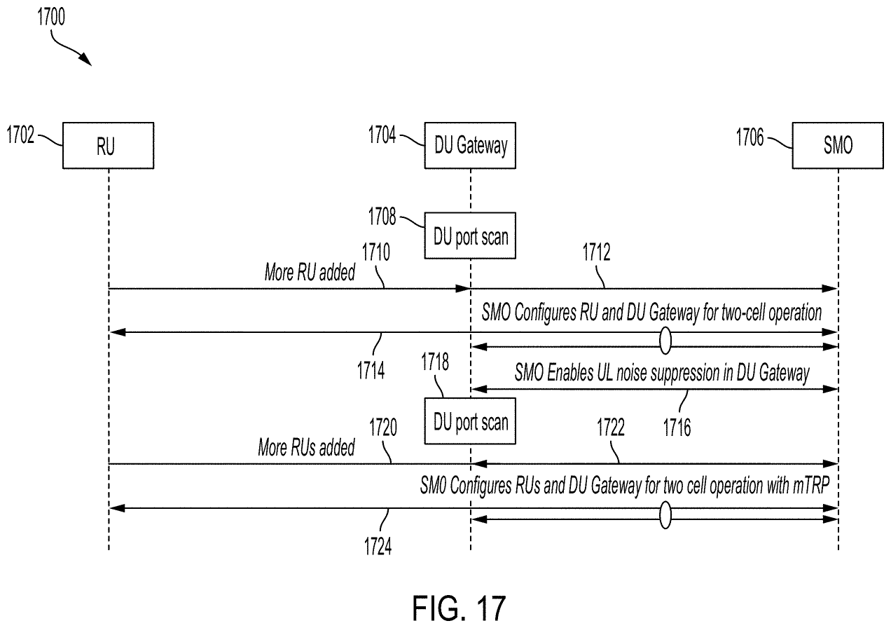

FIG. 17 is a data flow diagram 1700 corresponding to example operation of the third network cell configuration 1400 of FIG. 14, the fourth network cell configuration 1500 of FIG. 15, or the fifth network cell configuration 1600 of FIG. 16. The data flow diagram 1700 of FIG. 17 is implemented by one or more RUs 1702, a DU gateway 1704, and an SMO 1706. For example, the one or more RUs 1702 may be implemented by one(s) of the RUs 102 of FIGS. 1 and/or 8. The DU gateway 1704 in this example may be implemented by the DU gateway 802 of FIG. 8, the DU gateway 900 of FIG. 9, and/or the DU gateway circuitry 1000 of FIG. 10. The SMO 1706 of the illustrated example is an SMO platform.

The data flow diagram 1700 of the illustrated example of FIG. 17 begins at a first operation 1708, at which the DU gateway 1704 performs a port scan of ports (e.g., virtual ports, logical ports, physical ports, etc., and/or any combination(s) thereof) of the DU gateway 1704. After the port scan, the DU gateway 1704 determines that first and second ones of the RUs 1702 have been added at a second operation 1710 and relays the indication of the additions to the SMO 1706 at a third operation 1712. At a fourth operation 1714, the SMO 1706 receives the indication that multiple RUs have been added to effectuate two network cells, based on the port scan of the DU gateway 1704, and configures the DU gateway 1704 and the added RUs (via the DU gateway 1704) for two cell operation.

At a fifth operation 1716, in response to the addition of the multiple RUs for two cell operation, the SMO 1706 enables (or instructs the enabling of) UL noise suppression in the DU gateway 1704 for improved signal quality of UL data traffic processed by the DU gateway 1704. At a sixth operation 1718, the DU gateway 1704 performs (e.g., iteratively performs) another DU port scan of the ports of the DU gateway 1704. Responsive to the port scan, the DU gateway 1704 determines that third and fourth ones of the RUs 1702 have been added at a seventh operation 1720.

The DU gateway 1704 informs the SMO 1706 of the additions at an eighth operation 1722. At a ninth operation 1724, responsive to the informing, the SMO 1706 configures the added RUs and the DU gateway 1704 for two cell operation with Multi-TRP (identified by mTRP). For example, the SMO 1706 may instruct the DU gateway 1704 to associate the third RU with the first cell and the fourth RU with the second cell to implement overlapping network cells as described above in connection with FIG. 16.

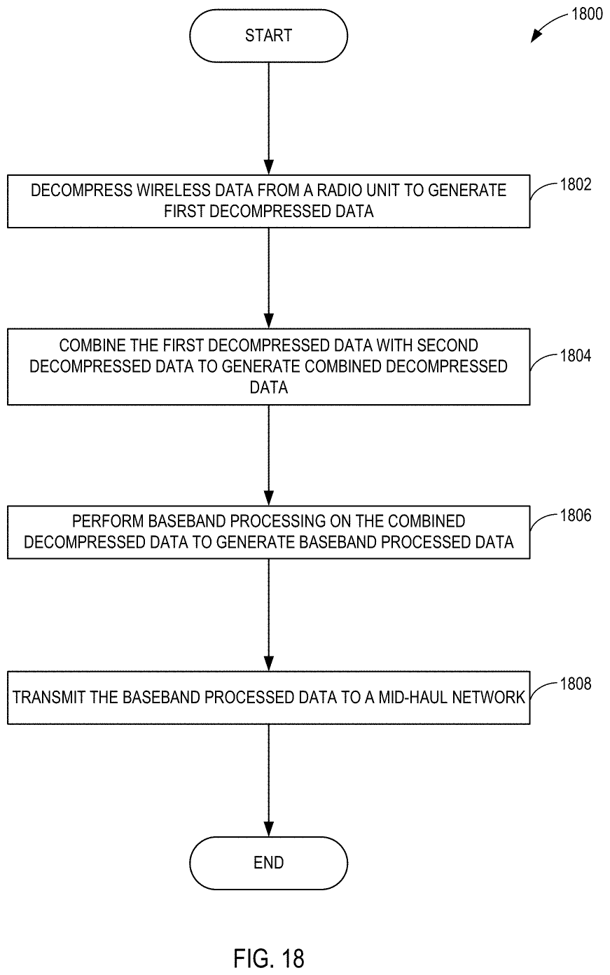

FIGS. 18-24 are flowcharts representative of machine-readable instructions that may be executed by processor circuitry to implement a DU gateway, such as the DU gateway 802 of FIG. 8, the DU gateway 900 of FIG. 9, the DU gateway circuitry 1000 of FIG. 10, etc. Although a flowchart may be discussed in connection with one of the DU gateway 802 of FIG. 8, the DU gateway 900 of FIG. 9, the DU gateway circuitry 1000 of FIG. 10, etc., the flowchart may also be applicable to any other one(s) of the DU gateway 802 of FIG. 8, the DU gateway 900 of FIG. 9, the DU gateway circuitry 1000 of FIG. 10, etc. Additionally or alternatively, block(s) of one(s) of the flowcharts of FIGS. 18, 19, 20, 21, 22, 23, and/or 24 may be representative of state(s) of one or more hardware-implemented state machines, algorithm(s) that may be implemented by hardware alone such as an ASIC, etc., and/or any combination(s) thereof.

FIG. 18 is a flowchart 1800 that may be executed to implement an uplink path of a cellular network. The flowchart 1800 of FIG. 18 begins at block 1802, at which the DU gateway 802 of FIG. 8 may decompress wireless data from a radio unit to generate first decompressed data. For example, the data decompression circuitry 1060 can decompress wireless data, associated with one of the UE 114, from one of the RUs 102 of FIG. 8 using any data decompression technique described herein. In some examples, the wireless data may include first compressed eCPRI messages received by the one of the RUs 102 at a first time and second compressed eCPRI messages received by the one of the RUs 102 at a second time after the first time. The data decompression circuitry 1060 may decompress the first and second compressed eCPRI messages to generate, output, etc., first and second decompressed eCPRI messages.

At block 1804, the DU gateway 802 may combine the first decompressed data with second decompressed data to generate combined decompressed data. For example, the traffic handling circuitry 1040 may identify the first and second decompressed eCPRI messages as being associated with the one of the UE 114 and being received by the same radio resource element (e.g., the one of the RUs 102). In some examples, the traffic handling circuitry 1040 may combine the first and second decompressed eCPRI messages into one or more combined decompressed eCPRI messages.

At block 1806, the DU gateway 802 may perform baseband processing on the combined decompressed data to generate baseband processed data. For example, the DU function circuitry 1030 may perform baseband processing, such as one or more high-PHY, MAC, and/or RLC functions on the combined decompressed eCPRI messages to generate baseband processed data (e.g., baseband processed eCPRI messages).

At block 1808, the DU gateway 802 may transmit the baseband processed data to a mid-haul network. For example, the interface circuitry 1010 may transmit (or cause transmission of) the baseband processed data to one of the CUs 108 via the mid-haul portion 120 of FIG. 8. After transmitting the baseband processing data to a mid-haul network at block 1808, the flowchart 1800 of FIG. 18 concludes.

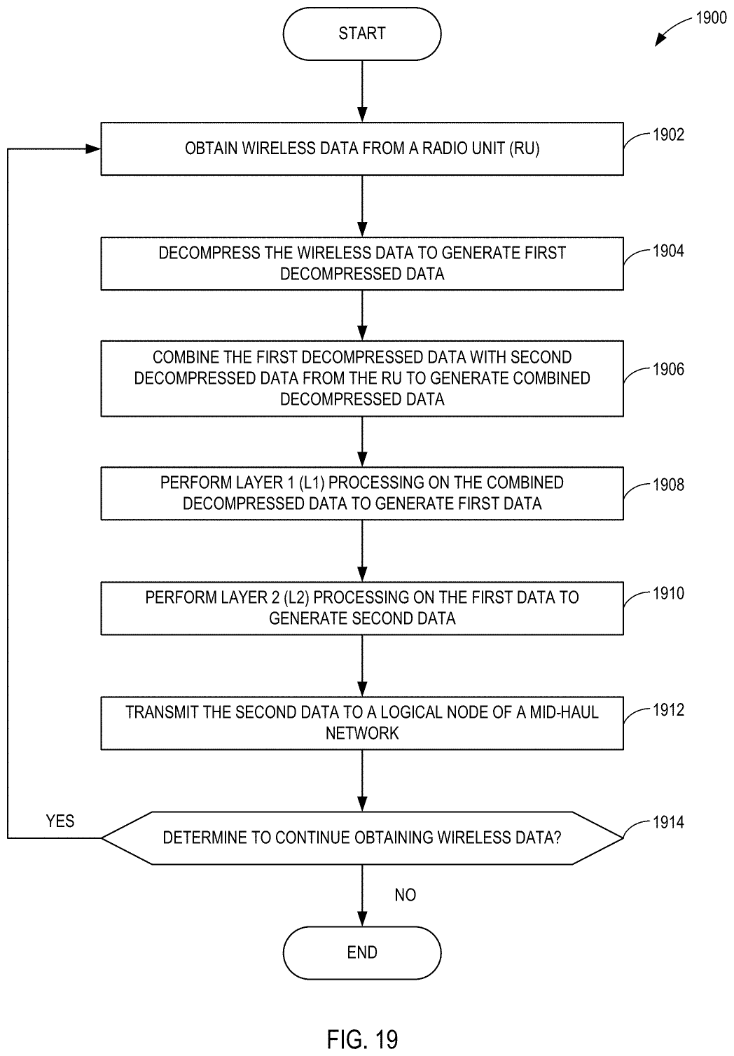

FIG. 19 is another flowchart 1900 that may be executed to implement an uplink path of a cellular network. The flowchart 1900 of FIG. 19 begins at block 1902, at which the DU gateway 900 of FIG. 9 may obtain wireless data from a radio unit (RU). For example, a first one of the first NIs 906 may obtain wireless data including a first eCPRI message from a first one of the RUs 902 (identified by RU₁).

At block 1904, the DU gateway 900 may decompress the wireless data to generate first decompressed data. For example, a first one of the comp/decomp functions 908 may decompress the first eCPRI message into a first decompressed eCPRI message via any data decompression technique described herein.

At block 1906, the DU gateway 900 may combine the first decompressed data with second decompressed data from the RU to generate combined decompressed data. For example, the DL traffic distribution and UL traffic combining and routing function 910 may combine first portion(s) of the first decompressed eCPRI message with second portion(s) of a second decompressed eCPRI message, which is received by RU₁ and is associated with the same UE as the first decompressed eCPRI message. The DL traffic distribution and UL traffic combining and routing function 910 may combine the first and second portions to generate a combined decompressed eCPRI message.

At block 1908, the DU gateway 900 may perform Layer 1 (L1) processing on the combined decompressed data to generate first data. For example, a first one of the DU instances 912 (identified by DU₁) may perform L1 processing by performing one or more high-PHY functions on the combined decompressed eCPRI message to generate first data.

At block 1910, the DU gateway 900 may perform Layer 2 (L2) processing on the first data to generate second data. For example, DU₁ may perform L2 processing by performing one or more MAC and/or RLC functions on the first data to generate second data.

At block 1912, the DU gateway 900 may transmit the second data to a logical node of a mid-haul network. For example, the second NI 914 may output the second data to the mid-haul network 904.

At block 1914, the DU gateway 900 may determine whether to continue obtaining wireless data. For example, one(s) of the first NIs 906 may determine to continue obtaining wireless data based on a determination that UL data traffic is being received. If, at block 1914, the DU gateway 900 determines to continue obtaining wireless data, control returns to block 1902. Otherwise, the flowchart 1900 of FIG. 19 concludes.

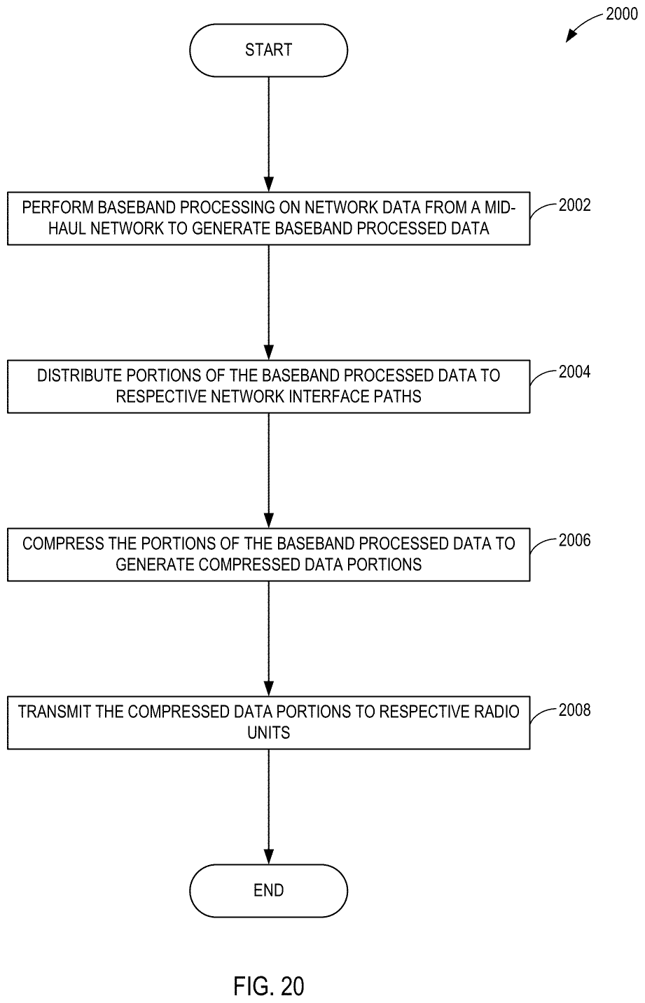

FIG. 20 is a flowchart 2000 that may be executed to implement a downlink path of a cellular network. The flowchart 2000 of FIG. 20 begins at block 2002, at which the DU gateway 802 of FIG. 8 may perform baseband processing on network data from a mid-haul network to generate baseband processed data. For example, the DU function circuitry 1030 may perform L1 processing, L2 processing, etc., and/or any combination(s) thereof, on network data from one of the CUs 108 via the mid-haul portion 120 of FIG. 8 to generate baseband processed data.

At block 2004, the DU gateway 802 may distribute portions of the baseband processed data to respective network interface paths. For example, the traffic handling circuitry 1040 may generate copies of the baseband processed data or copies of portions of the baseband processed data. In some examples, the traffic handling circuitry 1040 may distribute a first copy of the baseband processed data to a first network interface path, which may correspond to a first one of the RUs 102, a second copy of the baseband processed data to a second network interface path, which may correspond to a second one of the RUs 102, etc.

At block 2006, the DU gateway 802 may compress the portions of the baseband processed data to generate compressed data portions. For example, the data compression circuitry 1050 may compress the first copy, the second copy, etc., into a first compressed copy, a second compressed copy, etc., using any data compression technique described herein.

At block 2008, the DU gateway 802 may transmit the compressed data portions to respective radio units. For example, the interface circuitry 1010 may transmit (or cause transmission of) the first compressed copy to the first one of the RUs 102, the second compressed copy to the second one of the RUs 102, etc. After transmitting the compressed data portions to respective radio units at block 2008, the flowchart 2000 of FIG. 20 concludes.

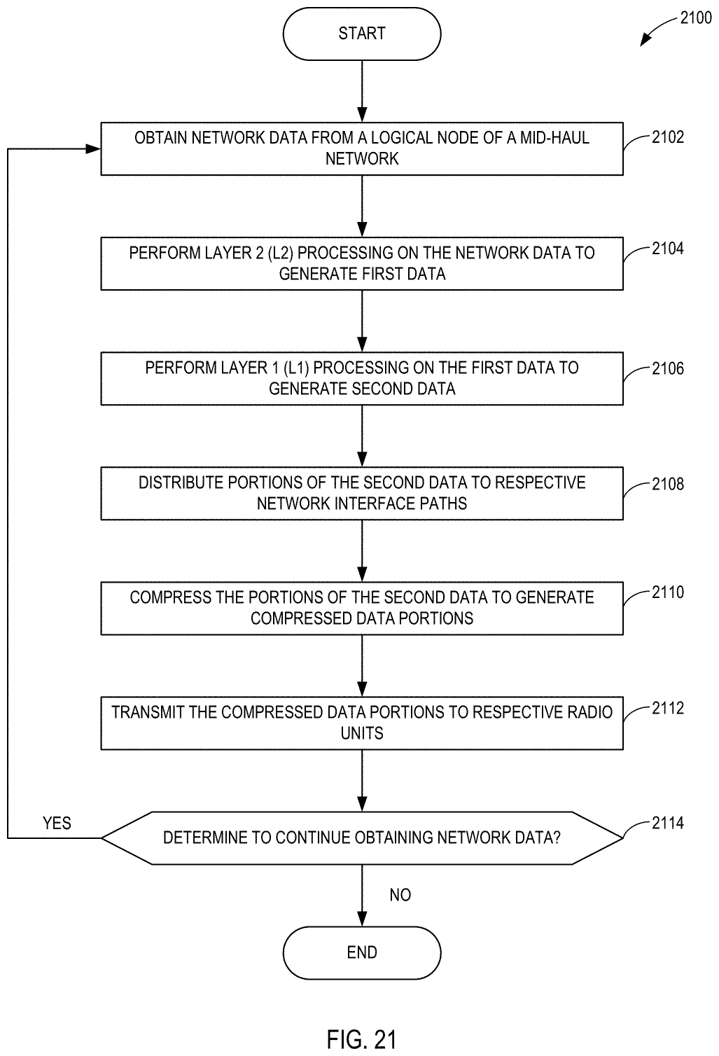

FIG. 21 is another flowchart 2100 that may be executed to implement a downlink path of a cellular network. The flowchart 2100 of FIG. 21 begins at block 2102, at which the DU gateway 900 of FIG. 9 may obtain network data from a logical node of a mid-haul network. For example, the second NI 914 may obtain network data from a logical node, such as a CU, of the mid-haul network 904. In some examples, the network data may include configuration data (e.g., to configure the DU gateway 900, one(s) of the RUs 902, etc.), Ethernet frames/packets that may include eCPRI messages, etc., and/or any combination(s) thereof.

At block 2104, the DU gateway 900 may perform Layer 2 (L2) processing on the network data to generate first data. For example, one or more of the DU instances 912 may perform one or more L2 processing operations, such as MAC and/or RLC operation(s), on an eCPRI message from the mid-haul network 904 to generate first data.

At block 2106, the DU gateway 900 may perform Layer 1 (L1) processing on the first data to generate second data. For example, the one or more of the DU instances 912 may perform one or more L1 processing operations, such as high-PHY operation(s), on the first data to generate second data.

At block 2108, the DU gateway 900 may distribute portions of the second data to respective network interface paths. For example, the DL traffic distribution and UL traffic combining and routing function 910 may distribute portion(s) (e.g., a payload, a header, etc.) of the second data to a first one of the comp/decomp functions 908, a second one of the comp/decomp functions 908, etc. In some examples, the DL traffic distribution and UL traffic combining and routing function 910 may copy the second data into multiple instances of the second data. For example, the DL traffic distribution and UL traffic combining and routing function 910 may copy the second data into a first copy and a second copy, output the first copy to a first one of the comp/decomp functions 908, and output the second copy to a second one of the comp/decomp functions 908.

At block 2110, the DU gateway 900 may compress the portions of the second data to generate compressed data portions. For example, the first one of the comp/decomp functions 908 may compress the portion(s) (or the first copy) into a first compressed portion (or a first compressed copy). In some examples, the second one of the comp/decomp functions 908 may compress the portion(s) (or the second copy) into a second compressed portion (or a second compressed copy).

At block 2112, the DU gateway 900 may transmit the compressed data portions to respective radio units. For example, a first one of the first NIs 906, which may be communicatively, logically, and/or physically coupled to the first one of the comp/decomp functions 908, may transmit (or cause transmission) of the portion(s) (or the first copy) to a first one of the RUs 902 (identified by RU₁). In some examples, a second one of the first NIs 906, which may be communicatively, logically, and/or physically coupled to the second one of the comp/decomp functions 908, may transmit (or cause transmission) of the portion(s) (or the second copy) to a second one of the RUs 902 (identified by RU₂).

At block 2114, the DU gateway 900 may determine whether to continue obtaining network data. For example, the second NI 914 may determine to continue obtaining network data in response to detecting a heartbeat signal, data packet, etc., from the mid-haul network 904 indicative of an active communication connection, channel, etc. If, at block 2114, the DU gateway 900 determines to continue obtaining network data, control returns to block 2102. Otherwise, the flowchart 2100 of FIG. 21 concludes.

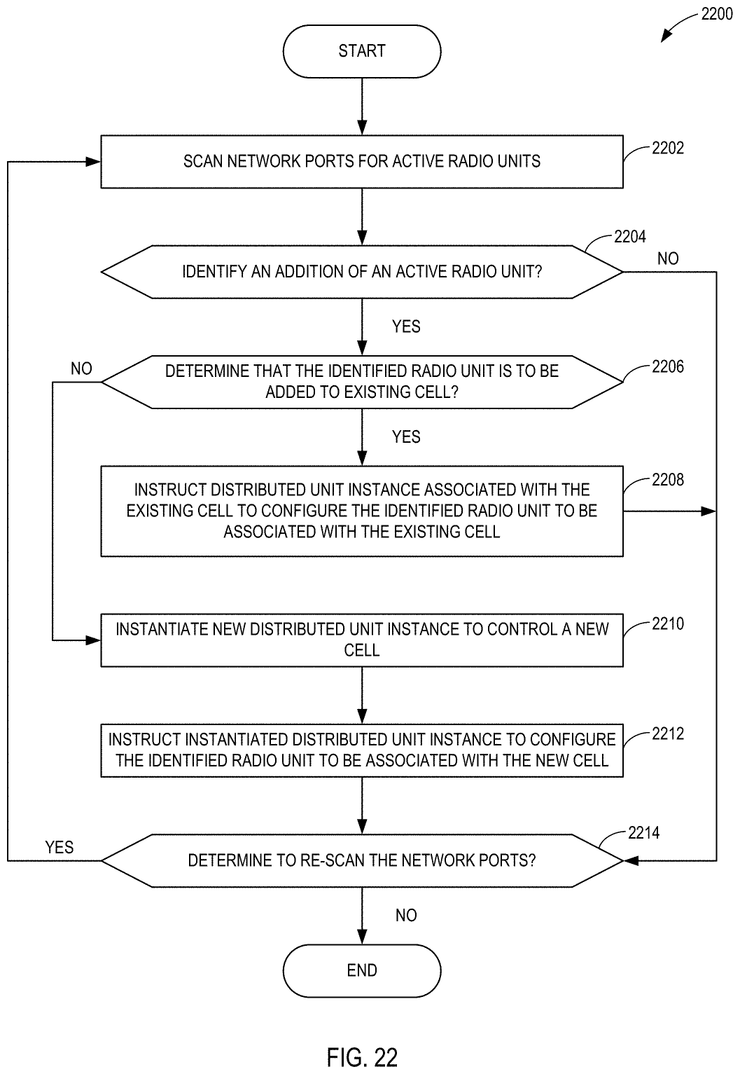

FIG. 22 is a flowchart 2200 that may be executed to perform network port scanning for a front-haul interface of a cellular network. The flowchart 2200 of FIG. 22 begins at block 2202, at which the first DU gateway 1610 of FIG. 16 may scan network ports for active radio units. For example, the interface circuitry 1010 may scan ports of the first DU gateway 1610 to identify any new or existing active RUs.

At block 2204, the first DU gateway 1610 may determine whether an addition of an active radio unit has been identified. For example, the interface circuitry 1010 may detect, based on the port scan, that one of the first RUs 1616 is active and not yet been associated with a network cell (e.g., the one of the first RUs 1616 is recently added, initialized, and/or powered to an online state).

If, at block 2204, the first DU gateway 1610 does not identify an addition of an active radio, control proceeds to block 2214. Otherwise, control proceeds to block 2206, at which the first DU gateway 1610 may determine whether the identified radio unit is to be added to an existing cell. For example, the interface circuitry 1010 may determine that the new RU is to be added an existing cell, such as the first network cell 1602, or a not yet instantiated cell.

If, at block 2206, the first DU gateway determines that the identified radio unit is to be added to an existing cell, control proceeds to block 2208. At block 2208, the first DU gateway 1610 may instruct a distributed unit instance associated with the existing cell to configure the identified radio unit to be associated with the existing cell. For example, the interface circuitry 1010 may instruct the DU function circuitry 1030, which may implement a first DU instance (e.g., DU₁ of FIG. 9), to associate the new RU with the first network cell 1602. After instructing the distributed unit instance at block 2208, control proceeds to block 2214.

If, at block 2206, the first DU gateway 1610 determines that the identified radio unit is not to be added to an existing cell, control proceeds to block 2210. At block 2210, the first DU gateway 1610 may instantiate a new distributed unit instance to control a new cell. For example, the DU function circuitry 1030 may instantiate a second DU instance (e.g., DU₂ of FIG. 9) to manage, control, etc., a new network cell, such as the second network cell 1604 of FIG. 16.

At block 2212, the first DU gateway 1610 may instruct the instantiated distributed unit instance to configure the identified radio unit to be associated with the new cell. For example, the DU function circuitry 1030 may direct the second DU instance to associate the new RU with the second network cell 1604.

At block 2214, the first DU gateway 1610 may determine whether to re-scan the network ports. For example, the interface circuitry 1010 may determine to scan (or re-scan) the DU ports aperiodically or periodically. If, at block 2214, the first DU gateway 1610 determines to re-scan the network ports, control returns to block 2202. Otherwise, the flowchart 2200 of FIG. 22 concludes.

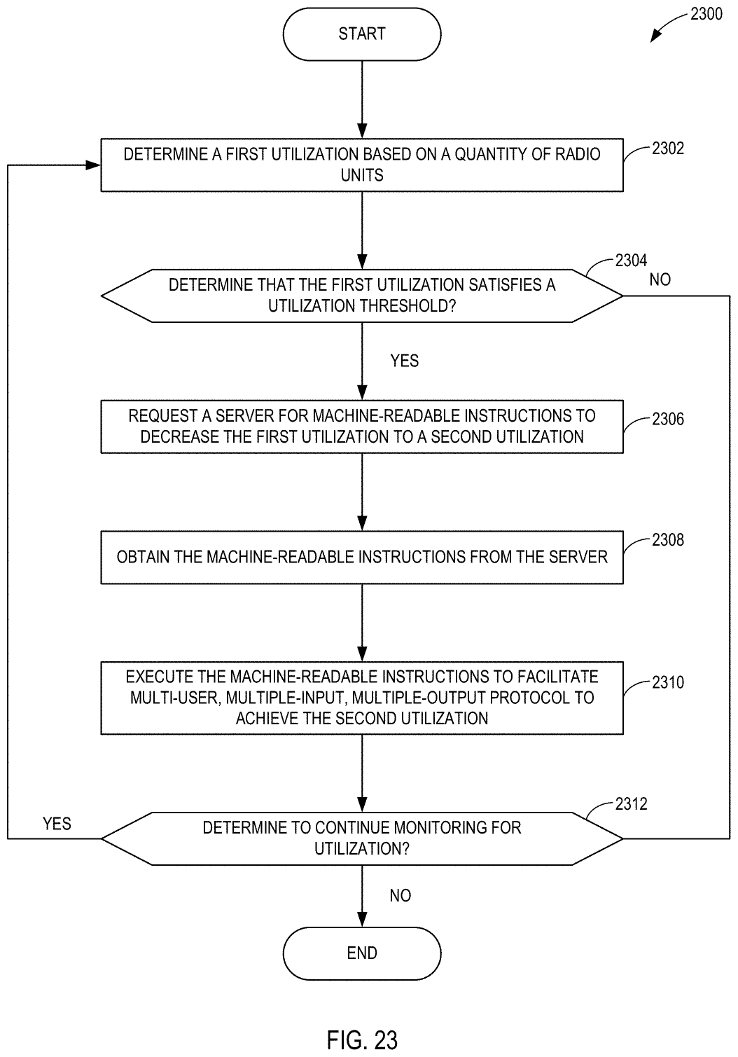

FIG. 23 is a flowchart 2300 that may be executed to perform updates associated with utilization improvements of a DU gateway. The flowchart 2300 begins at block 2302, at which the DU gateway circuitry 1000 may determine a first utilization of the DU gateway circuitry 1000 based on a quantity of radio units. For example, the traffic handling circuitry 1040 may determine a first utilization (e.g., a compute/processing utilization, a bandwidth utilization, a throughput utilization, etc.) of the DU gateway circuitry 1000, or portion(s) thereof, based on a number of RUs in communication and/or otherwise associated with the DU gateway circuitry 1000.

At block 2304, the DU gateway circuitry 1000 may determine whether the first utilization satisfies a utilization threshold. For example, the traffic handling circuitry 1040 may determine that the first utilization, such as a throughput utilization (or any other utilization) of the interface circuitry 1010, meets and/or exceeds a utilization threshold (e.g., a throughput utilization threshold or any other utilization-based threshold). In some examples, based on the determination, the traffic handling circuitry 1040 may determine that the interface circuitry 1010 is overutilized and may be causing a processing bottleneck that degrades system performance.

If, at block 2304, the DU gateway circuitry 1000 may determine that the first utilization does not satisfy a utilization threshold (e.g., the first utilization is below the throughput utilization threshold), control proceeds to block 2312. Otherwise, control proceeds to block 2306.

At block 2306, the DU gateway circuitry 1000 may request a server for machine-readable instructions to decrease the first utilization to a second utilization. For example, the interface circuitry 1010 may request a server, such as a physical and/or virtualized server of the cloud 112 of FIG. 8, for a firmware and/or software update to improve the utilization of the interface circuitry 1010 (and/or another component of the DU gateway circuitry 1000) by reducing the first utilization to a second utilization.

At block 2308, the DU gateway circuitry 1000 may obtain the machine-readable instructions from the server. For example, the interface circuitry 1010, responsive to the request, may receive machine-readable instructions representative of an executable file that, when executed by the DU gateway circuitry 1000, may reconfigure the DU gateway circuitry 1000, or portion(s) thereof, for improved utilization. In some examples, the reconfiguration may include the installing, configuring, and/or enabling of MU-MIMO, Multi-TRP, etc., functions to decrease the first utilization to a second utilization.

At block 2310, the DU gateway circuitry 1000 may execute the machine-readable instructions to facilitate multi-user, multiple-input, multiple-output protocol to achieve the second utilization. For example, the traffic handling circuitry 1040, or different portion(s) of the DU gateway circuitry 1000, may execute MU-MIMO functions or any other function to decrease the first utilization of the DU gateway circuitry 1000, or portion(s) thereof, to the second utilization, which is less than the first utilization.

At block 2312, the DU gateway circuitry 1000 may determine whether to continue monitoring for utilization. For example, the traffic handling circuitry 1040 may determine to continue monitoring the DU gateway circuitry 1000, or portion(s) thereof, for changes in utilization and whether the changes indicate that the DU gateway circuitry 1000, or portion(s) thereof, is/are overutilized.

If, at block 2312, the DU gateway circuitry 1000 determines to continue monitoring for utilization, control returns to block 2302. Otherwise, the flowchart 2300 of FIG. 23 concludes.

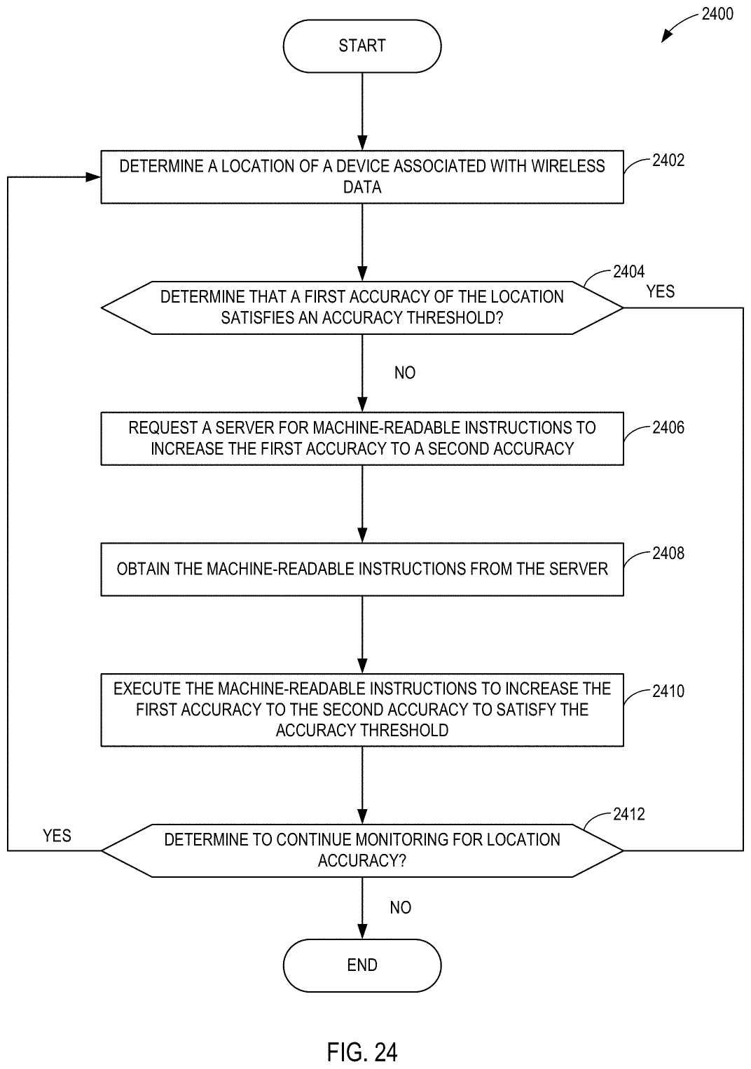

FIG. 24 is a flowchart 2400 that may be executed to perform updates associated with location accuracy improvements of a DU gateway. The flowchart 2400 of FIG. 24 begins at block 2402, at which the DU gateway circuitry 1000 may determine a location of a device associated with wireless data. For example, the interface circuitry 1010 may receive wireless data, transmitted by UE, from an RU, such as one of the RUs 102 of FIG. 8. In some examples, the DU function circuitry 1030 may determine a location of the UE based on the wireless data. For example, the DU function circuitry 1030 may store the wireless data in the datastore 1070 as the wireless data 1072 and/or the location in the datastore 1070 as the location data 1074.

At block 2404, the DU gateway circuitry 1000 may determine whether a first accuracy of the location satisfies an accuracy threshold. For example, the DU function circuitry 1030 may determine that the location has an accuracy of +/−0.3 kilometers (km). In some examples, the DU function circuitry 1030 may determine that the accuracy of 0.3 km is greater than an accuracy threshold of 0.1 km and thereby does not satisfy the accuracy threshold. In some examples, the DU function circuitry 1030 may determine that the accuracy of 0.3 km is less than an accuracy threshold of 0.5 km and thereby satisfies the accuracy threshold.

If, at block 2404, the DU gateway circuitry 1000 determines that a first accuracy of the location satisfies an accuracy threshold, control proceeds to block 2412. Otherwise, control proceeds to block 2406. At block 2406, the DU gateway circuitry 1000 may request a server for machine-readable instructions to increase the first accuracy to a second accuracy. For example, the interface circuitry 1010 may request a server, such as a server associated with the cloud 112 of FIG. 8, for an executable file that, when executed by the DU function circuitry 1030, may determine locations of UE with increased accuracy.

At block 2408, the DU gateway circuitry 1000 may obtain the machine-readable instructions from the server. For example, in response to the request, the interface circuitry 1010 may receive the executable file from the server.

At block 2410, the DU gateway circuitry 1000 may execute the machine-readable instructions to increase the first accuracy to the second accuracy to satisfy the accuracy threshold. For example, the DU function circuitry 1030 may execute the executable file to reconfigure, update, etc., portion(s) of the DU function circuitry 1030, or any other portion(s) of the DU gateway circuitry 1000, to determine UE locations with improved accuracy, such as accuracies that may satisfy the accuracy threshold.

At block 2412, the DU gateway circuitry 1000 may determine whether to continue monitoring for location accuracy. For example, the DU function circuitry 1030 may determine to continue analyzing whether UE location determinations meet and/or exceed the accuracy threshold. If, at block 2412, the DU gateway circuitry 1000 determines to continue monitoring for location accuracy, control returns to block 2402. Otherwise, the flowchart 2400 of FIG. 24 concludes.

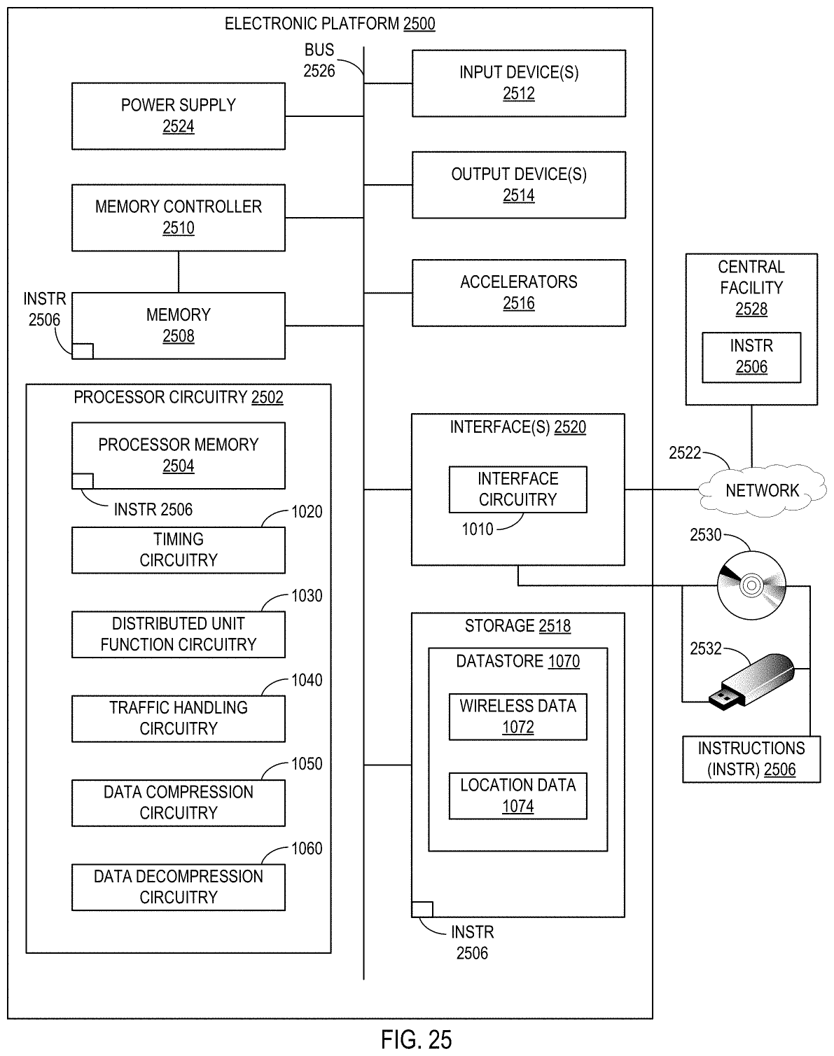

FIG. 25 is an example implementation of an electronic platform 2500 structured to execute the machine-readable instructions of FIGS. 18-24 to implement a DU gateway, such as the DU gateway 802 of FIG. 8, the DU gateway 900 of FIG. 9, the DU gateway circuitry 1000 of FIG. 10, etc. It should be appreciated that FIG. 25 is intended neither to be a description of necessary components for an electronic and/or computing device to operate as a DU gateway or DU gateway circuitry, in accordance with the techniques described herein, nor a comprehensive depiction. The electronic platform 2500 of this example may be an electronic device, such as a desktop computer, a laptop computer, a server (e.g., a computer server, a blade server, a rack-mounted server, etc.), a cellular network device, or any other type of computing and/or electronic device.

The electronic platform 2500 of the illustrated example includes processor circuitry 2502, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, etc., and/or any combination(s) thereof. The processor circuitry 2502 includes processor memory 2504, which may be volatile memory, such as random-access memory (RAM) of any type. The processor circuitry 2502 of this example implements the timing circuitry 1020, the distributed unit function circuitry 1030, the traffic handling circuitry 1040, the data compression circuitry 1050, and the data decompression circuitry 1060 of FIG. 10.

The processor circuitry 2502 may execute machine-readable instructions 2506 (identified by INSTRUCTIONS), which are stored in the processor memory 2504, to implement at least one of the timing circuitry 1020, the distributed unit function circuitry 1030, the traffic handling circuitry 1040, the data compression circuitry 1050, or the data decompression circuitry 1060. The machine-readable instructions 2506 may include data representative of computer-executable and/or machine-executable instructions implementing techniques that operate according to the techniques described herein. For example, the machine-readable instructions 2506 may include data (e.g., code, embedded software (e.g., firmware), software, etc.) representative of the flowcharts of FIGS. 18, 19, 20, 21, 22, 23, and/or 24, or portion(s) thereof.

The electronic platform 2500 includes memory 2508, which may include the instructions 2506. The memory 2508 of this example may be controlled by a memory controller 2510. For example, the memory controller 2510 may control reads, writes, and/or, more generally, access(es) to the memory 2508 by other component(s) of the electronic platform 2500. The memory 2508 of this example may be implemented by volatile memory, non-volatile memory, etc., and/or any combination(s) thereof. For example, the volatile memory may include static random-access memory (SRAM), dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 2500 includes input device(s) 2512 to enable data and/or commands to be entered into the processor circuitry 2502. For example, the input device(s) 2512 may include an audio sensor, a camera (e.g., a still camera, a video camera, etc.), a keyboard, a microphone, a mouse, a touchscreen, a voice recognition system, etc., and/or any combination(s) thereof.

The electronic platform 2500 includes output device(s) 2514 to convey, display, and/or present information to a user (e.g., a human user, a machine user, etc.). For example, the output device(s) 2514 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 2514 can be used, among other things, to generate, launch, and/or present a user interface. For example, the user interface may be generated and/or implemented by the output device(s) 2514 for visual presentation of output and speakers or other sound generating devices for audible presentation of output.

The electronic platform 2500 includes accelerators 2516, which are hardware devices to which the processor circuitry 2502 may offload compute tasks to accelerate their processing. For example, the accelerators 2516 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In some examples, one or more of the timing circuitry 1020, the distributed unit function circuitry 1030, the traffic handling circuitry 1040, the data compression circuitry 1050, and/or the data decompression circuitry 1060 may be implemented by one(s) of the accelerators 2516 instead of the processor circuitry 2502. In some examples, the timing circuitry 1020, the distributed unit function circuitry 1030, the traffic handling circuitry 1040, the data compression circuitry 1050, and/or the data decompression circuitry 1060 may be executed concurrently (e.g., in parallel, substantially in parallel, etc.) by the processor circuitry 2502 and the accelerators 2516. For example, the processor circuitry 2502 and one(s) of the accelerators 2516 may execute in parallel function(s) corresponding to the data compression circuitry 1050.

The electronic platform 2500 includes storage 2518 to record and/or control access to data, such as the machine-readable instructions 2506. In this example, the storage 2518 may implement the datastore 1070, the wireless data 1072, and the location data 1074. The storage 2518 may be implemented by one or more mass storage disks or devices, such as HDDs, SSDs, etc., and/or any combination(s) thereof.

The electronic platform 2500 includes interface(s) 2520 to effectuate exchange of data with external devices (e.g., computing and/or electronic devices of any kind) via a network 2522. In this example, the interface(s) 2520 may implement the interface circuitry 1010 of FIG. 10. The interface(s) 2520 of the illustrated example may be implemented by an interface device, such as network interface circuitry (e.g., a NIC, a smart NIC, etc.), a gateway, a router, a switch, etc., and/or any combination(s) thereof. The interface(s) 2520 may implement any type of communication interface, such as BLUETOOTH®, a cellular telephone system (e.g., a 4G LTE interface, a 5G interface, a 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-C™ or USB-C™, etc.), etc., and/or any combination(s) thereof.

The electronic platform 2500 includes a power supply 2524 to store energy and provide power to components of the electronic platform 2500. The power supply 2524 may be implemented by a power converter, such as an alternating current-to-direct-current (AC/DC) power converter, a direct current-to-direct current (DC/DC) power converter, etc., and/or any combination(s) thereof. For example, the power supply 2524 may be powered by an external power source, such as an alternating current (AC) power source (e.g., an electrical grid), a direct current (DC) power source (e.g., a battery, a battery backup system, etc.), etc., and the power supply 2524 may convert the AC input or the DC input into a suitable voltage for use by the electronic platform 2500. In some examples, the power supply 2524 may be a limited duration power source, such as a battery (e.g., a rechargeable battery such as a lithium-ion battery).

Component(s) of the electronic platform 2500 may be in communication with one(s) of each other via a bus 2526. For example, the bus 2526 may be any type of computing and/or electrical bus, such as an I2C bus, a PCI bus, a PCIe bus, a SPI bus, and/or the like.

The network 2522 may be implemented by any wired and/or wireless network(s) such as one or more cellular networks (e.g., 4G LTE cellular networks, 5G cellular networks, 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 2522 may be the Internet, but any other type of private and/or public network is contemplated.

The network 2522 of the illustrated example facilitates communication between the interface(s) 2520 and a central facility 2528. The central facility 2528 in this example may be an entity associated with one or more servers, such as one or more physical hardware servers and/or virtualizations of the one or more physical hardware servers. For example, the central facility 2528 may be implemented by a public cloud provider, a private cloud provider, etc., and/or any combination(s) thereof. In this example, the central facility 2528 may compile, generate, update, etc., the machine-readable instructions 2506 and store the machine-readable instructions 2506 for access (e.g., download) via the network 2522. For example, the electronic platform 2500 may transmit a request, via the interface(s) 2520, to the central facility 2528 for the machine-readable instructions 2506 and receive the machine-readable instructions 2506 from the central facility 2528 via the network 2522 in response to the request.

Additionally or alternatively, the interface(s) 2520 may receive the machine-readable instructions 2506 via non-transitory machine-readable storage media, such as an optical disc 2530 (e.g., a Blu-ray disc, a CD, a DVD, etc.) or any other type of removable non-transitory machine-readable storage media such as a USB drive 2532. For example, the optical disc 2530 and/or the USB drive 2532 may store the machine-readable instructions 2506 thereon and provide the machine-readable instructions 2506 to the electronic platform 2500 via the interface(s) 2520.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a DSP circuit or an ASIC, or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. For example, the flowcharts, or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In some examples, the flowcharts, or portion(s) thereof, may be implemented by machine-executable instructions (e.g., machine-readable instructions, computer-readable instructions, computer-executable instructions, etc.) that, when executed by one or more single- or multi-purpose processors, carry out the various processes of the flowcharts. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

When techniques described herein are embodied as machine-executable instructions, these machine-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc., that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (e.g., as a single unit or separate units), or some of these functional facilities may not be implemented.

Machine-executable instructions implementing the techniques described herein (when implemented as one or more functional facilities or in any other manner) may, in some embodiments, be encoded on one or more computer-readable media, machine-readable media, etc., to provide functionality to the media. Computer-readable media include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium may be implemented in any suitable manner. As used herein, the terms “computer-readable media” (also called “computer-readable storage media”) and “machine-readable media” (also called “machine-readable storage media”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques—such as implementations where the techniques are implemented as machine-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.). Functional facilities comprising these machine-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more FPGAs for carrying out the techniques described herein, or any other suitable system.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

Various aspects are described in this disclosure, which include, but are not limited to, the following aspects:
1. A method for processing wireless data by a baseband gateway in a cell deployment, the method comprising decompressing wireless data received from a radio unit to generate first decompressed data; combining the first decompressed data with second decompressed data to generate combined decompressed data, wherein the second decompressed data is associated with the radio unit; performing baseband processing on the combined decompressed data to generate baseband processed data; and transmitting the baseband processed data to a mid-haul network.
2. The method of aspect 1, wherein the wireless data is first wireless data associated with a wireless device, the radio unit is a first radio unit, and the method further comprising: obtaining second wireless data associated with the wireless device from a second radio unit; decompressing the second wireless data to generate third decompressed data; and generating the combined decompressed data based on a combination of the first decompressed data, the second decompressed data, and the third decompressed data.
3. The method of aspect 2, wherein the first radio unit and the second radio unit are in the same network cell.
4. The method of aspect 2, wherein the first radio unit is in a first network cell and the second radio unit is in a second network cell.
5. The method of aspect 2, wherein the first radio unit is in a first network cell and is associated with a second network cell to execute multi transmission and reception point operations.
6. The method of aspect 1, wherein the radio unit is a first radio unit, and the method further comprising: obtaining the wireless data from the first radio unit via a network interface of the baseband gateway directly coupled to the first radio unit by a first wired connection, wherein the baseband gateway is directly coupled to a second radio unit via a second wired connection.
7. The method of aspect 6, wherein the network interface is a first network interface, and the baseband gateway is directly coupled to the mid-haul network via a second network interface.
8. The method of aspect 7, wherein the baseband gateway is coupled to a centralized unit via the mid-haul network via the second network interface.
9. The method of aspect 1, wherein the performing of the baseband processing includes performing Telecom-Boundary Clock processing.
10. The method of aspect 1, wherein the performing of the baseband processing implements a distributed unit logical node and a switch logical node, and a single physical unit includes the distributed unit logical node and the switch logical node.
11. The method of aspect 10, wherein the distributed unit logical node hosts at least one of high physical, media access control, or radio link control layers of the Open Radio Access Network architecture.
12. The method of aspect 1, further comprising performing noise suppression processing on the first decompressed data to reduce a noise floor of the first decompressed data.
13. The method of aspect 1, wherein the radio unit is a first radio unit, and the method further comprising: scanning a plurality of network ports, wherein the first radio unit is configured to transmit to a first network port of the plurality of network ports, and the first radio unit is associated with a network cell; after identifying an addition of a second radio unit to a second network port based on the scanning, instructing a distributed unit instance to configure the second radio unit to be associated with the network cell; and suppressing uplink noise associated with the network cell.
14. The method of aspect 13, wherein the network cell is a first network cell, the distributed unit instance is a first distributed unit instance, and the method further comprising: instantiating the first distributed unit instance to be associated with the first network cell; after identifying an addition of a third radio unit to a third network port based on the scanning, instantiating a second distributed unit instance to be associated with a second network cell; and instructing the second distributed unit instance to configure the third radio unit to be associated with the second network cell.
15. The method of aspect 14, further comprising executing the distributed unit instance using a virtual machine or a container.
16. The method of aspect 1, further comprising: determining a first utilization of the baseband gateway based on a quantity of radio units in communication with the baseband gateway; in response to determining that the first utilization is above a utilization threshold, obtaining machine-readable instructions from a server; and executing the machine-readable instructions to facilitate multi-user, multiple-input, multiple-output protocol to decrease the first utilization to a second utilization.
17. The method of aspect 1, further comprising determining a location of a device associated with the wireless data.
18. The method of aspect 17, further comprising: in response to determining that a first accuracy of the location is below an accuracy threshold, obtaining machine-readable instructions from a server; and executing the machine-readable instructions to increase the first accuracy to a second accuracy, the second accuracy to be above the accuracy threshold.
19. The method of aspect 1, wherein there is no compression of the combined decompressed data before the performing of the baseband processing on the combined decompressed data.
20. The method of aspect 1, wherein the combined decompressed data is not output to a network interface before the performing of the baseband processing on the combined decompressed data.
21. A method for processing wireless data by a baseband gateway in a cell deployment, the method comprising: performing baseband processing on network data from a mid-haul network to generate baseband processed data; distributing at least portions of the baseband processed data to respective network interface paths; compressing the portions of the baseband processed data to generate compressed data portions; and transmitting the compressed data portions to respective radio units.
22. The method of aspect 21, wherein the transmitting of the compressed data portions to the respective radio units include: transmitting a first compressed data portion of the compressed data portions to a first radio unit of the respective radio units via a first network interface of the baseband gateway directly coupled to the first radio unit by a first wired connection; and transmitting a second compressed data portion of the compressed data portions to a second radio unit of the respective radio units via a second network interface of the baseband gateway directly coupled to the second radio unit by a second wired connection.
23. The method of aspect 21, wherein the baseband gateway is directly coupled to the mid-haul network via a network interface.
24. The method of aspect 21, wherein the performing of the baseband processing includes performing Telecom-Boundary Clock processing.
25. The method of aspect 21, wherein the performing of the baseband processing implements a distributed unit logical node and a switch logical node, and a single physical unit includes the distributed unit logical node and the switch logical node.
26. The method of aspect 25, wherein the distributed unit logical node hosts at least one of high physical, media access control, or radio link control layers of the Open Radio Access Network architecture.
27. The method of aspect 21, wherein the respective radio units include a first radio unit and a second radio unit, and the method further comprising: scanning a plurality of network ports, wherein the first radio unit is configured to transmit to a first network port of the plurality of network ports, and the first radio unit is associated with a network cell; and after identifying an addition of a third radio unit to a second network port based on the scanning, instructing a distributed unit instance to configure the third radio unit to be associated with the network cell.
28. The method of aspect 27, wherein the network cell is a first network cell, the distributed unit instance is a first distributed unit instance, and the method further comprising: instantiating the first distributed unit instance to be associated with the first network cell; after identifying an addition of a fourth radio unit to a third network port based on the scanning, instantiating a second distributed unit instance to be associated with a second network cell; and instructing the second distributed unit instance to configure the fourth radio unit to be associated with the second network cell.
29. The method of aspect 28, further comprising executing the distributed unit instance using a virtual machine or a container.
30. The method of aspect 21, further comprising: determining a first utilization of the baseband gateway based on a quantity of radio units in communication with the baseband gateway; in response to determining that the first utilization is above a utilization threshold, obtaining machine-readable instructions from a server; and executing the machine-readable instructions to facilitate multi-user, multiple-input, multiple-output protocol to decrease the first utilization to a second utilization capacity.
31. The method of aspect 21, wherein the respective radio units include a first radio unit and a second radio unit, and wherein the first radio unit and the second radio unit are in the same network cell.
32. The method of aspect 21, wherein the respective radio units include a first radio unit and a second radio unit, and wherein the first radio unit is in a first network cell and the second radio unit is in a second network cell.
33. The method of aspect 21, wherein the respective radio units include a first radio unit and a second radio unit, and wherein the first radio unit is in a first network cell and is associated with a second network cell to execute multi transmission and reception point operations.
34. The method of aspect 21, wherein a distributed unit instance performs the baseband processing, and the method further comprising outputting, with the distributed unit instance, the baseband processed data to traffic combining and routing logic, and the baseband processed data is not output to a network interface between the distributed unit instance and the traffic combining and routing logic before the distributing of the baseband processed data to the respective network interface paths.
35. The method of aspect 21, wherein there is no decompression of the baseband processed data before the distributing of the baseband processed data to the respective network interface paths.
36. A baseband gateway comprising a memory storing instructions, and a processor configured to execute the instructions to perform the method of any one of claims 1-35.
37. At least one non-transitory computer-readable storage medium comprising instructions that, when executed, cause a baseband gateway to perform the method of any one of claims 1-35.
38. A system comprising a memory storing instructions, and a processor configured to execute the instructions to perform the method of any one of claims 1-35.

1. A method for processing wireless data by a baseband gateway in a cell deployment, the method comprising:
decompressing wireless data received from a radio unit to generate first decompressed data;
combining the first decompressed data with second decompressed data to generate combined decompressed data, wherein the second decompressed data is associated with the radio unit;
performing baseband processing on the combined decompressed data to generate baseband processed data; and
transmitting the baseband processed data to a mid-haul network.

2. The method of claim 1, wherein the wireless data is first wireless data associated with a wireless device, the radio unit is a first radio unit, and the method further comprising:
obtaining second wireless data associated with the wireless device from a second radio unit;
decompressing the second wireless data to generate third decompressed data; and
generating the combined decompressed data based on a combination of the first decompressed data, the second decompressed data, and the third decompressed data.

3. The method of claim 2, wherein the first radio unit and the second radio unit are in the same network cell.

4. The method of claim 2, wherein the first radio unit is in a first network cell and the second radio unit is in a second network cell.

5. The method of claim 2, wherein the first radio unit is in a first network cell and is associated with a second network cell to execute multi transmission and reception point operations.

6. The method of claim 1, wherein the radio unit is a first radio unit, and the method further comprising:
obtaining the wireless data from the first radio unit via a network interface of the baseband gateway directly coupled to the first radio unit by a first wired connection, wherein the baseband gateway is directly coupled to a second radio unit via a second wired connection.

7. The method of claim 6, wherein the network interface is a first network interface, and the baseband gateway is directly coupled to the mid-haul network via a second network interface.

8. The method of claim 7, wherein the baseband gateway is coupled to a centralized unit via the mid-haul network via the second network interface.

9. (canceled)

10. The method of claim 1, wherein the performing of the baseband processing implements a distributed unit logical node and a switch logical node, and a single physical unit includes the distributed unit logical node and the switch logical node.

11. The method of claim 10, wherein the distributed unit logical node hosts at least one of high physical, media access control, or radio link control layers of the Open Radio Access Network architecture.

12. The method of claim 1, further comprising performing noise suppression processing on the first decompressed data to reduce a noise floor of the first decompressed data.

13. The method of claim 1, wherein the radio unit is a first radio unit, and the method further comprising:
scanning a plurality of network ports, wherein the first radio unit is configured to transmit to a first network port of the plurality of network ports, and the first radio unit is associated with a network cell;
after identifying an addition of a second radio unit to a second network port based on the scanning, instructing a distributed unit instance to configure the second radio unit to be associated with the network cell; and
suppressing uplink noise associated with the network cell.

14. The method of claim 13, wherein the network cell is a first network cell, the distributed unit instance is a first distributed unit instance, and the method further comprising:
instantiating the first distributed unit instance to be associated with the first network cell;
after identifying an addition of a third radio unit to a third network port based on the scanning, instantiating a second distributed unit instance to be associated with a second network cell; and
instructing the second distributed unit instance to configure the third radio unit to be associated with the second network cell.

15. (canceled)

16. The method of claim 1, further comprising:
determining a first utilization of the baseband gateway based on a quantity of radio units in communication with the baseband gateway;
in response to determining that the first utilization is above a utilization threshold, obtaining machine-readable instructions from a server; and
executing the machine-readable instructions to facilitate multi-user, multiple-input, multiple-output protocol to decrease the first utilization to a second utilization.

17. The method of claim 1, further comprising determining a location of a device associated with the wireless data.

18. The method of claim 17, further comprising:
in response to determining that a first accuracy of the location is below an accuracy threshold, obtaining machine-readable instructions from a server; and
executing the machine-readable instructions to increase the first accuracy to a second accuracy, the second accuracy to be above the accuracy threshold.

19. The method of claim 1, wherein there is no compression of the combined decompressed data before the performing of the baseband processing on the combined decompressed data.

20. The method of claim 1, wherein the combined decompressed data is not output to a network interface before the performing of the baseband processing on the combined decompressed data.

21-38. (canceled)

39. A baseband gateway for processing wireless data in a cell deployment, the baseband gateway comprising:
at least one memory;
machine-readable instructions; and
processor circuitry to execute the machine-readable instructions to at least:
decompress wireless data received from a radio unit to generate first decompressed data;
combine the first decompressed data with second decompressed data to generate combined decompressed data, wherein the second decompressed data is associated with the radio unit;
perform baseband processing on the combined decompressed data to generate baseband processed data; and
cause transmission of the baseband processed data to a mid-haul network.

40. At least one non-transitory computer-readable storage medium comprising instructions that, when executed, cause a baseband gateway to at least:
decompress wireless data received from a radio unit to generate first decompressed data;
combine the first decompressed data with second decompressed data to generate combined decompressed data, wherein the second decompressed data is associated with the radio unit;
perform baseband processing on the combined decompressed data to generate baseband processed data; and
cause transmission of the baseband processed data to a mid-haul network.
